(19) United States
(12) Patent Application Publication
(10) Pub. No.: US 2012/0078640 A1
(43) Pub. Date: Mar. 29, 2012

(54) AUDIO ENCODING DEVICE, AUDIO ENCODING METHOD, AND COMPUTER-READABLE MEDIUM STORING AUDIO-ENCODING COMPUTER PROGRAM

(75) Inventors: Miyuki SHIRAKAWA, Fukuoka (JP); Yohei Kishi, Kawasaki (JP); Masanao Suzuki, Kawasaki (JP); Yoshiteru Tsuchinaga, Fukuoka (JP)

(73) Assignee: Fujitsu Limited, Kawasaki (JP)

(21) Appl. No.: 13/176,932

(22) Filed: Jul. 6, 2011

(30) Foreign Application Priority Data
Sep. 28, 2010 (JP) 2010-217263

(51) Int. Cl. G10L 19/00

(52) U.S. Cl. 704/500; 704/E19.001

(57) ABSTRACT

An audio encoding device includes, a time-frequency transformer that transforms signals of channels, a first spatial-information determiner that generates a frequency signal of a third channel, a second spatial-information determiner that generates a frequency signal of the third channel, a similarity calculator that calculates a similarity between the frequency signal of the at least one first channel and the frequency signal of the at least one second channel, a phase-difference calculator that calculates a phase difference between the frequency signal of the at least one first channel and the signal of the at least one second channel, a controller that controls determination of the first spatial information when the similarity and the phase difference satisfy a predetermined determination condition, a channel-signal encoder that encodes the frequency signal of the third channel, and a spatial-information encoder that encodes the first spatial information or the second spatial information.

### CROSS-REFERENCE TO RELATED APPLICATIONS

This application is based upon and claims the benefit of priority of the prior Japanese Patent Application No. 2010-217263, filed on Sep. 28, 2010, the entire contents of which are incorporated herein by reference.

### FIELD

Various embodiments disclosed herein relate to an audio encoding device, an audio encoding method, and a computer-readable medium having an audio-encoding computer program embodied therein.

### BACKGROUND

There has been developed audio-signal coding for compressing the amounts of data of multi-channel audio signals carrying three or more channels. One known coding is the MPEG Surround standardized by the Moving Picture Experts Group (MPEG). According to the MPEG Surround, for example, 5.1-channel audio signals to be encoded are subjected to time-frequency transform and the resulting frequency signals are downmixed, so that frequency signals of three channels are temporarily generated. The frequency signals of the three channels are downmixed again, so that frequency signals for stereo signals of two channels are obtained. The frequency signals for the stereo signals are then encoded according to advanced audio coding (AAC) and spectral band replication (SBR) coding. According to the MPEG Surround, during downmixing of 5.1-channel signals into signals of three channels and during downmixing of signals of three channels into signals of two channels, spatial information representing spread or localization of sound is determined and is encoded. In the MPEG Surround, the stereo signals generated by downmixing the multi-channel audio signals and the spatial information having a relatively small amount of data are encoded as described above. Thus, the MPEG Surround offers high compression efficiency, compared to a case in which the signals of the respective channels which are included in the multi-channel audio signals are interpedently encoded.

According to the MPEG Surround, an energy-based mode and a prediction mode are used as modes for encoding spatial information determined during generation of the stereo frequency signals. In the energy-based mode, the spatial information is determined as two types of parameter representing the ratio of power of channels for each frequency band. On the other hand, in the prediction mode, the spatial information is represented by three types of parameter for each frequency band. Two of the three types of parameter are prediction coefficients for predicting the signal of one of the three channels on the basis of the signals of the other two channels. The other one is the ratio of power of input sound to prediction sound, which represents a prediction value of audio played back using the prediction coefficients.

Thus, since the number of parameters determined as the spatial information in the energy-based mode is fewer than the number of parameters determined as the spatial information in the prediction mode, the compression efficiency in the energy-based mode is higher than the compression efficiency in the prediction mode. On the other hand, since a large amount of information can be held in the prediction mode than in the energy-based mode, playback audio of audio signals encoded in the prediction mode has a higher quality than playback audio of audio signals encoded in the energy-based mode. Accordingly, it is preferable that an optimum one of such two types of coding be selected according to audio signals to be encoded.

In relation to coding for encoding stereo audio signals, for example, International Publication Pamphlet No. 95/08227 discusses a technology for selecting an appropriate type of coding from multiple types of coding on the basis of audio signals to be encoded. In such a technology, the selectable types of coding include, for example, channel-separated coding and intensity-stereo coding for encoding signals of fewer channels than the number of the original channels and supplementary information representing signal distribution. As one example of such a technology, the signals of the respective channels are transformed into spectral values in a frequency domain, and a listening threshold is calculated by a psychoacoustic computation on the basis of the spectral values. A similarity between the signals of the channels is then determined based on actual audio spectral components selected or evaluated using the listening threshold. When the similarity exceeds a predetermined threshold, the channel-separated coding is used, and when the similarity is smaller than or equal to the predetermined threshold, the intensity-stereo coding is used.

### SUMMARY

In accordance with an aspect of the embodiments, an audio encoding device includes, a time-frequency transformer that transforms signals of channels included in audio signals into frequency signals of respective channels by performing time-frequency transform for each frame having a predetermined time length, a first spatial-information determiner that generates a frequency signal of a third channel by downmixing the frequency signal of at least one first channel of the channels and the frequency signal of at least one second channel of the channels and that determines first spatial information with respect to the frequency signal of the at least one first channel and the frequency signal of the at least one second channel, and a second spatial-information determiner that generates a frequency signal of the third channel by downmixing the frequency signal of the at least one first channel and the frequency signal of the at least one second channel and that determines second spatial information with respect to the frequency signal of the at least one first channel and the frequency signal of the at least one second channel, where the second spatial information is a smaller amount of information than the first spatial information.

The audio encoding device, according to an embodiment, includes a similarity calculator that calculates a similarity between the frequency signal of the at least one first channel and the frequency signal of the at least one second channel, a phase-difference calculator that calculates a phase difference between the frequency signal of the at least one first channel and the frequency signal of the at least one second channel, a controller that controls determination of the first spatial information when the similarity and the phase difference satisfy a predetermined determination condition and determination of the second spatial information when the similarity and the phase difference do not satisfy the predetermined determination condition, a channel-signal encoder that encodes the frequency signal of the third channel, and a spatial-information encoder that encodes the first spatial information or the second spatial information.

Additional aspects and/or advantages will be set forth in part in the description which follows and, in part, will be apparent from the description, or may be learned by practice of the invention.

Objects and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

These and/or other aspects and advantages will become apparent and more readily appreciated from the following description of the embodiments, taken in conjunction with the accompanying drawing of which:

FIG. 1 is a schematic block diagram of an audio encoding device according to an embodiment;

FIG. 2 illustrates one example of a quantization table that stores quantization prediction coefficients that can be used as prediction coefficients;

FIG. 3 is an operation flowchart of a spatial-information generation-mode selection processing;

FIG. 4 illustrates one example of a quantization table for similarities;

FIG. 5 illustrates one example of a table indicating the relationships between index difference values and similarity codes;

FIG. 6 illustrates one example of a quantization table for intensity differences;

FIG. 7 illustrates one example of a quantization table for prediction coefficients;

FIG. 8 illustrates one example of the format of data containing encoded audio signals;

FIG. 9 is a flowchart illustrating an operation of an audio encoding processing;

FIG. 10A illustrates one example of a center-channel signal of original multi-channel audio signals;

FIG. 10B illustrates one example of a center-channel playback signal decoded using spatial information generated in an energy-based mode during encoding of the original multi-channel audio signals;

FIG. 10C illustrates one example of a center-channel playback signal of the multi-channel audio signals encoded by the audio encoding device according to an embodiment;

FIG. 11 is an operation flowchart of a spatial-information generation-mode selection processing in an embodiment;

FIG. 12 is a schematic block diagram of an audio encoding device according to an embodiment;

FIG. 13 is an operation flowchart of a spatial-information generation-mode selection processing according to an embodiment; and

FIG. 14 is a schematic block diagram of a video transmitting apparatus incorporating an audio encoding device according an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Since the coding to be selected in the related technologies described above varies depending on which of the energy-based mode and the prediction mode is used, appropriate coding is not necessarily always selected therefrom even when the selection technologies are used. When only the similarity between the signals of the channels is used as an index for selecting the coding, there is a possibility that appropriate coding is not necessarily always selected. As a result, the amount of data encoded is not sufficiently reduced or the sound quality when encoded audio signals are played back may deteriorate to a degree perceivable by a listener.

An audio encoding device according to embodiments is described below with reference to the accompanying drawings.

As a result of extensive research, the inventors have found that, for encoding of spatial information in the energy-based mode when multi-channel audio signals of sound recorded under a certain condition are encoded using the MPEG Surround, the playback sound quality of the encoded signals deteriorates significantly. In particular, for example, when the similarity between signals of two channels which are downmixed is high and the phase difference therebetween is large, the playback sound quality of the encoded signals deteriorates considerably. Such a situation can easily occur with multi-channel audio signals resulting from recording of sound, such as audio at an orchestra performance or concert, produced by sound sources whose signals concentrate at front channels.

When two-channel signals included in the multi-channel audio signals of sound recorded under the condition described above are downmixed, the signals of the respective channels may cancel each other out and the amplitude of the downmixed signals is attenuated. Thus, when the energy-based mode in which the amount of spatial information is small is used, the signals of the respective channels are not accurately reproduced by decoded audio signals and thus the amplitude of played back signals of the channels becomes smaller than the amplitude of the original signals of the channels.

Accordingly, when the similarity between the signals of two channels is high and the phase difference therebetween is large, an audio encoding device uses the prediction mode in which the amount of spatial information is relatively large. Otherwise, the audio encoding device uses the energy-based-mode in which the amount of spatial information is relatively small.

In an embodiment, the multi-channel audio signals to be encoded are assumed to be 5.1-channel audio signals. While particular signals are used as example, as clearly described herein the present invention is not limited to any particular signals.

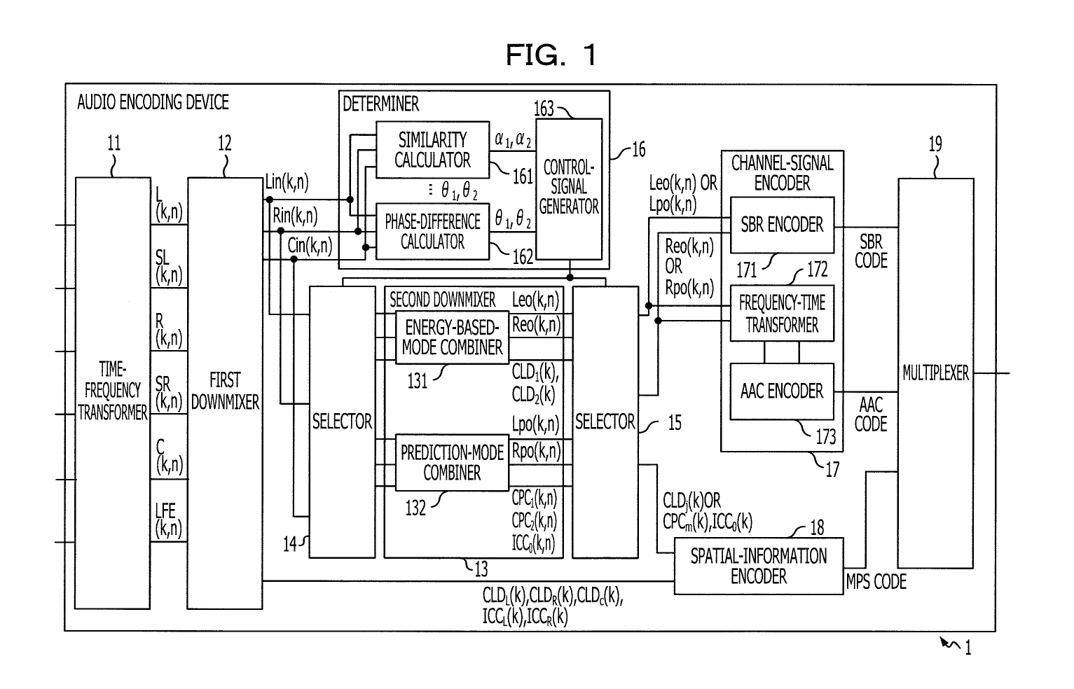

FIG. 1 is a schematic block diagram of an audio encoding device 1 according to one embodiment. As illustrated in FIG. 1, the audio encoding device 1 includes a time-frequency transformer 11, a first downmixer 12, a second downmixer 13, selectors 14 and 15, a determiner 16, a channel-signal encoder 17, a spatial-information encoder 18, and a multiplexer 19.

The individual units included in the audio encoding device 1 may be implemented as discrete circuits, respectively. Alternatively, the individual units included in the audio encoding device 1 may be realized as, in the audio encoding device 1, a single integrated circuit into which circuits corresponding to the individual units are integrated. The units included in the audio encoding device 1 may also be implemented by functional modules realized by a computer program executed by a processor included in the audio encoding device 1. Accordingly, one or more components of the audio encoding device 1 may be implemented in computing hardware (computing apparatus) and/or software.

The time-frequency transformer 11 transforms the time-domain channel signals of the multi-channel audio signals, input to the audio encoding device 1, into frequency signals of the channels, by performing time-frequency transform for each frame.

In an embodiment, the time-frequency transformer 11 transforms the signals of the channels into frequency signals by using a quadrature mirror filter (QMF) bank expressed by:

$$QMF ( k , n ) = exp [ j \frac{π}{128} ( k + 0.5 ) ( 2 n + 1 ) ] , \\ 0 \leq k < 64 , 0 \leq n < 128 \qquad ( 1 )$$

where n is a variable indicating time, and represents the nth time of times obtained by equally dividing audio signals for one frame by 128 in a time direction. The frame length may be, for example, any of 10 to 80 msec. Also k is a variable indicating a frequency band, and represents the kth frequency band of bands obtained by equally dividing a frequency band carrying frequency signals by 64. QMF(k,n) indicates a QMF for outputting frequency signals at time n and with a frequency k. The time-frequency transformer 11 multiplies input audio signals for one frame for a channel by QMF(k,n), to thereby generate frequency signals of the channel.

The time-frequency transformer 11 may also employ other time-frequency transform processing, such as fast Fourier transform, discrete cosine transform, or modified discrete cosine transform, to transform the signals of the channels into frequency signals.

Each time the time-frequency transformer 11 determines the frequency signals of the channels for each frame, the time-frequency transformer 11 outputs the frequency signals of the channels to the first downmixer 12.

Each time the first downmixer 12 receives the frequency signals of the channels, it downmixes the frequency signals of the channels to generate frequency signals of a left channel, a center channel, and a right channel. For example, the first downmixer 12 determines the frequency signals of the three channels in accordance with:

Lᵢₙ(k,n)=L_{inRe}(k,n)+j·L_{inIm}(k,n)0≦k<64,0≦n<128

L_{inRe}(k,n)=L_{Re}(k,n)+SL_{Re}(k,n)

L_{in Im}(k,n)=(k,n)+SL_{Im}(k,n)

Rᵢₙ(k,n)=R_{inRe}(k,n)+j·R_{inIm}(k,n)

R_{in Re}(k,n)=R_{Re}(k,n)+SR_{Re}(k,n)

R_{in Im}(k,n)=R_{Im}(k,n)+SR_{Im}(k,n)

Cᵢₙ(k,n)=C_{InRe}(k,n)+j·C_{in Im}(k,n)

C_{in Re}(k,n)=C_{Re}(k,n)+LFE_{Re}(k,n)

C_{inIm}(k,n)=C_{Im}(k,n)+LFE_{Im}(k,n) (2)

where L_{Re}(k,n) indicates a real part of a frequency signal L(k,n) of a front-left channel and L_{Im}(k,n) indicates an imaginary part of the frequency signal L(k,n) of the front-left channel. SL_{Re}(k,n) indicates a real part of a frequency signal SL(k,n) of a rear-left channel and SL_{Im}(k,n) indicates an imaginary part of the frequency signal SL(k,n) of the rear-left channel. Lᵢₙ(k,n) indicates a frequency signal of a left channel, the frequency signal being generated by downmixing. L_{in Re}(k,n) indicates a real part of the frequency signal of the left channel and L_{inIm}(k,n) indicates an imaginary part of the frequency signal of the left channel. Similarly, R_{Re}(k,n) indicates a real part of a frequency signal R(k,n) of a front-right channel and R_{Im}(k,n) indicates an imaginary part of the frequency signal R(k,n) of the front-right channel. SR_{Re}(k,n) indicates a real part of a frequency signal SR(k,n) of a rear-right channel and SR_{Im}(k,n) indicates an imaginary part of the frequency signal SR(k,n) of the rear-right channel. Rᵢₙ(k,n) indicates a frequency signal of a right channel, the frequency signal being generated by downmixing. R_{inRe}(k,n) indicates a real part of the frequency signal of the right channel and R_{inIm}(k,n) indicates an imaginary part of the frequency signal of the right channel. C_{Re}(k,n) indicates a real part of a frequency signal C(k,n) of a center channel and C_{Im}(k,n) indicates an imaginary part of the frequency signal C(k,n) of the center channel. LFE_{Re}(k,n) indicates a real part of a frequency signal LFE(k,n) of a deep-bass channel and LFE_{Im}(k,n) indicates an imaginary part of the frequency signal LFE(k,n) of the deep-bass channel. Cᵢₙ(k,n) indicates a frequency signal of a center channel, the frequency signal being generated by downmixing. C_{inRe}(k,n) indicates a real part of the frequency signal Cᵢₙ(k,n) of the center channel and C_{inIm}(k,n) indicates an imaginary part of the frequency signal Cᵢₙ(k,n) of the center channel.

The first downmixer 12 determines, for each frequency band, spatial information with respect to the frequency signals of two channels to be downmixed, specifically, an intensity difference between the frequency signals and a similarity between the frequency signals. The intensity difference is information indicating localization of sound and the similarity is information indicating spread of sound. Those pieces of spatial information determined by the first downmixer 12 are examples of spatial information of three channels. In an embodiment, the first downmixer 12 determines an intensity difference CLD_{L}(k) and a similarity ICC_{L}(k) for a frequency band k with respect to the left channel, in accordance with:

$$\begin{matrix}{CLD}_{L} ( k ) = 10 {log}_{10} ( \frac{{e}_{L} ( k )}{{e}_{SL} ( k )} ) & ( 3 ) \\ {ICC}_{L} ( k ) = Re \{ \frac{{e}_{LSL} ( k )}{\sqrt{{e}_{L} ( k ) \cdot {e}_{SL} ( k )}} \} \\ {e}_{L} ( k ) = {\sum }_{n = 0}^{N - 1} {\vert L ( k , n ) \vert}^{2} \\ {e}_{SL} ( k ) = {\sum }_{n = 0}^{N - 1} {\vert SL ( k , n ) \vert}^{2} \\ {e}_{LSL} ( k ) = {\sum }_{n = 0}^{N - 1} L ( k , n ) \cdot SL ( k , n ) & ( 4 )\end{matrix}$$

where N is the number of sample points in a time direction which are included in one frame and is 128 in an embodiment. Also, e_{L}(k) is an autocorrelation value of the frequency signal L(k,n) of the front-left channel and e_{SL}(k) is an autocorrelation value of the frequency signal SL(k,n) of the rear-left channel. Further, e_{LSL}(k) is a cross-correlation value between the frequency signal L(k,n) of the front-left channel and the frequency signal SL(k,n) of the rear-left channel. Similarly, the first downmixer 12 determines an intensity difference CLD_{R}(k) and a similarity ICC_{R}(k) for the frequency band k with respect to the right channel, in accordance with:

$$\begin{matrix}{CLD}_{R} ( k ) = 10 {log}_{10} ( \frac{{e}_{R} ( k )}{{e}_{SR} ( k )} ) & ( 5 ) \\ {ICC}_{R} ( k ) = Re \{ \frac{{e}_{RSR} ( k )}{\sqrt{{e}_{R} ( k ) \cdot {e}_{SR} ( k )}} \} \\ {e}_{R} ( k ) = {\sum }_{n = 0}^{N - 1} {\vert R ( k , n ) \vert}^{2} \\ {e}_{SR} ( k ) = {\sum }_{n = 0}^{N - 1} {\vert SR ( k , n ) \vert}^{2} \\ {e}_{RSR} ( k ) = {\sum }_{n = 0}^{N - 1} L ( k , n ) \cdot SR ( k , n ) & ( 6 )\end{matrix}$$

where e_{R}(k) is an autocorrelation value of the frequency signal R(k,n) of the front-right channel, e_{SR}(k) is an autocorrelation value of the frequency signal SR(k,n) of the rear-right channel, and e_{RSR}(k) is a cross-correlation value between the frequency signal R(k,n) of the front-right channel and the frequency signal SR(k,n) of the rear-right channel.

The first downmixer 12 determines an intensity difference CLD_{C}(k) for the frequency band k with respect to the center channel, in accordance with:

$${CLD}_{C} ( k ) = 10 {log}_{10} ( \frac{{e}_{C} ( k )}{{e}_{LFE} ( k )} ) \\ {e}_{C} ( k ) = {\sum }_{n = 0}^{N - 1} {\vert C ( k , n ) \vert}^{2} \\ {e}_{LFE} ( k ) = {\sum }_{n = 0}^{N - 1} {\vert LFE ( k , n ) \vert}^{2} \qquad ( 7 )$$

where e_{C}(k) is an autocorrelation value of the frequency signal C(k,n) of the center channel and e_{LFE}(k) is an autocorrelation value of the frequency signal LFE(k,n) of the deep-bass channel.

Each time the first downmixer 12 generates frequency signals of the three channels, it outputs the frequency signals of the three channels to the selector 14 and the determiner 16 and also outputs the spatial information to the spatial-information encoder 18.

The second downmixer 13 receives the frequency signals of the three channels, i.e., left, right, and center channels, via the selector 14, and downmixes the frequency signals of two of the three channels to generate stereo frequency signals of the two channels. The second downmixer 13 generates spatial information with respect to the two frequency signals to be downmixed, in accordance with an energy-based mode or a prediction mode. To this end, the second downmixer 13 has an energy-based-mode combiner 131 and a prediction-mode combiner 132. The determiner 16 (described below) selects one of the energy-based-mode combiner 131 and the prediction-mode combiner 132.

The energy-based-mode combiner 131 is one example of a second spatial-information determiner. The energy-based-mode combiner 131 generates a left-side frequency signal of stereo frequency signals by downmixing the left-channel frequency signal and the center-channel frequency signal. The energy-based-mode combiner 131 generates a right-side frequency signal of the stereo frequency signals by downmixing the right-channel frequency signal and the center-channel frequency signal.

For example, the energy-based-mode combiner 131 generates a left-side frequency signal Lₑ₀(k,n) and a right-side frequency signal Rₑ₀(k,n) of the stereo frequency signals in accordance with:

$$( \begin{matrix}{L}_{e 0} ( k , n ) \\ {R}_{e 0} ( k , n )\end{matrix} ) = ( \begin{matrix}1 & 0 & \frac{\sqrt{2}}{2} \\ 0 & 1 & \frac{\sqrt{2}}{2}\end{matrix} ) ( \begin{matrix}{L}_{ i n} ( k , n ) \\ {R}_{i n} ( k , n ) \\ {C}_{i n} ( k , n )\end{matrix} ) \qquad ( 8 )$$

where Lᵢₙ(k,n), Rᵢₙ(k,n), and Cᵢₙ(k,n) are the left-channel frequency signal, the right-channel frequency signal, and the center-channel frequency signal, respectively, generated by the first downmixer 12. As is apparent from equation (2) noted above, Lᵢₙ(k,n) is a combination of the front-left-channel frequency signal and the rear-left-channel frequency signal of the original multi-channel audio signals. Cᵢₙ(k,n) is a combination of the center-channel frequency signal and the deep-bass-channel frequency signal of the original multi-channel audio signals. Thus, the left-side frequency signal Lₑ₀(k,n) is a combination of the front-left-channel frequency signal, the rear-left-channel frequency signal, the center-channel frequency signal, and the deep-bass-channel frequency signal of the original multi-channel audio signals. Similarly, the right-side frequency signal Rₑ₀(k,n) is a combination of the front-right-channel frequency signal, the rear-right-channel frequency signal, the center-channel frequency signal, and the deep-bass-channel frequency signal of the original multi-channel audio signals.

In addition, in accordance with the energy-based mode, the energy-based-mode combiner 131 determines spatial information regarding two-channel frequency signals downmixed. More specifically, the energy-based-mode combiner 131 determines, as the spatial information, a power ratio CLD1(k) of the left-and-right channels to the center channel for each frequency band and a power ratio CLD2(k) of the left channel to the right channel, in accordance with:

$${CLD}_{1} ( k ) = 10 {log}_{10} ( \frac{{e}_{{L}_{i n}} ( k ) + {e}_{{R}_{i n}} ( k )}{{e}_{{C}_{i n}} ( k )} ) \\ {CLD}_{2} ( k ) = 10 {log}_{10} ( \frac{{e}_{{L}_{i n}} ( k )}{{e}_{{R}_{i n}} ( k )} ) \\ {e}_{{L}_{i n}} ( k ) = {\sum }_{n = 0}^{N - 1} {\vert {L}_{i n} ( k , n ) \vert}^{2} \\ {e}_{{R}_{i n}} ( k ) = {\sum }_{n = 0}^{N - 1} {\vert {R}_{i n} ( k , n ) \vert}^{2} \\ {e}_{{C}_{i n}} ( k ) = {\sum }_{n = 0}^{N - 1} {\vert {C}_{i n} ( k , n ) \vert}^{2} \qquad ( 9 )$$

where e_{Lin}(k) is an autocorrelation value of the left-channel frequency signal Lᵢₙ(k,n) in the frequency band k, e_{Rin}(k) is an autocorrelation value of the right-channel frequency signal Rᵢₙ(k,n) in the frequency band k, and e_{Cin}(k) is an autocorrelation value of the center-channel frequency signal Cᵢₙ(k,n) in the frequency band k.

The energy-based-mode combiner 131 outputs the stereo frequency signals Lₑ₀(k,n) and Rₑ₀(k,n) to the channel-signal encoder 17 via the selector 15. The energy-based-mode combiner 131 also outputs the spatial information CLD₁(k) and CLD₂(k) to the spatial-information encoder 18 via the selector 15.

The prediction-mode combiner 132 is one example of a first spatial-information determiner. The prediction-mode combiner 132 generates a left-side frequency signal of stereo frequency signals by downmixing the left-channel frequency signal and the center-channel frequency signal. The prediction-mode combiner 132 also generates a right-side frequency signal of the stereo frequency signals by downmixing the right-channel frequency signal and the center-channel frequency signal.

For example, the prediction-mode combiner 132 generates a left-side frequency signal Lₚ₀(k,n), a right-side frequency signal Rₚ₀(k,n), and a center-channel signal Cₚ₀(k,n), which is used for generating spatial information, of the stereo frequency signals in accordance with:

$$( \begin{matrix}{L}_{p 0} ( k , n ) \\ {R}_{p 0} ( k , n ) \\ {C}_{p 0} ( k , n )\end{matrix} ) = ( \begin{matrix}1 & 0 & \frac{\sqrt{2}}{2} \\ 0 & 1 & \frac{\sqrt{2}}{2} \\ 1 & 1 & - \frac{\sqrt{2}}{2}\end{matrix} ) ( \begin{matrix}{L}_{ i n} ( k , n ) \\ {R}_{i n} ( k , n ) \\ {C}_{i n} ( k , n )\end{matrix} ) \qquad ( 10 )$$

where Lᵢₙ(k,n), Rᵢₙ(k,n), and Cᵢₙ(k,n) are the left-channel frequency signal, the right-channel frequency signal, and the center-channel frequency signal, respectively, generated by the first downmixer 12. Similarly to the stereo frequency signals generated by the energy-based-mode combiner 131, the left-side frequency signal Lₚ₀(k,n) is a combination of the front-left-channel frequency signal, the rear-left-channel frequency signal, the center-channel frequency signal, and the deep-bass-channel frequency signal of the original multi-channel audio signals. Similarly, the right-side frequency signal Rₚ₀(k,n) is a combination of the front-right-channel frequency signal, the rear-right-channel frequency signal, the center-channel frequency signal, and the deep-bass-channel frequency signal of the original multi-channel audio signals.

In accordance with the prediction mode, the prediction-mode combiner 132 determines spatial information regarding two-channel frequency signals downmixed. More specifically, the prediction-mode combiner 132 determines, for each frequency band, prediction coefficients CPC₁(k) and CPC₂(k) as spatial information so as to minimize an error Error(k) for Cₚ₀′(k,n) determined from Cₚ₀(k,n), Lₚ₀(k,n), and Rₚ₀(k,n) in accordance with:

$${C}_{p 0}^{′} ( k , n ) = {CPC}_{1} ( k ) \cdot {L}_{p 0} ( k , n ) + {CPC}_{2} ( k ) \cdot {R}_{p 0} ( k , n ) \\ Error ( k ) = {\sum }_{n = 0}^{N - 1} {( {C}_{p 0}^{′} ( k , n ) - {C}_{p 0} ( k , n ) )}^{2} \qquad ( 11 )$$

The prediction-mode combiner 132 may also select the prediction coefficients CPC₁(k) and CPC₂(k) from predetermined quantization prediction coefficients so as to minimize the error Error(k).

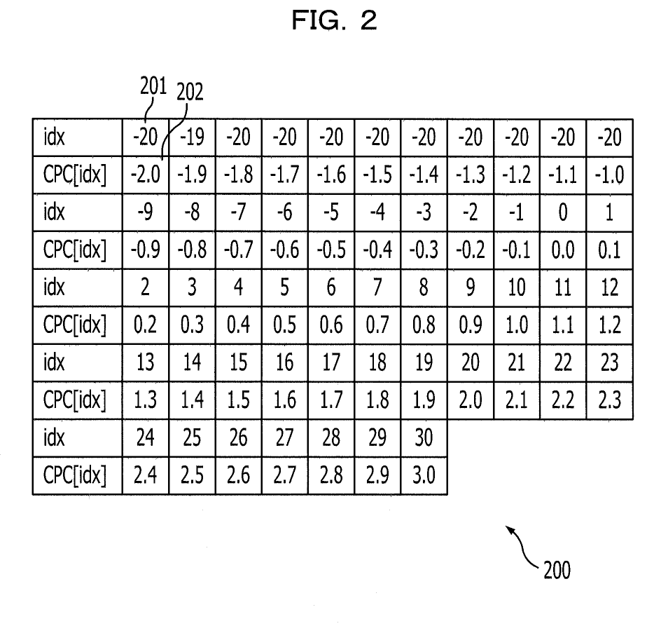

FIG. 2 illustrates one example of a quantization table that stores quantization prediction coefficients that can be used as the prediction coefficients. As illustrated in FIG. 2, in a quantization table 200, two adjacent rows are paired to indicate prediction coefficients. A numeric value in each field in the row with its leftmost column indicating “idx” represents an index. A numeric value in each field in the row with its leftmost column indicating “CPC[idx]” represents a prediction coefficient associated with the index in the field immediately thereabove. For example, an index value of “−20” is contained in a field 201 and a prediction coefficient “−2.0” associated with the index value of “−20” is contained in a field 202.

In addition, for each frequency band, the prediction-mode combiner 132 determines, as the spatial information, the power ratio (i.e., the similarity) ICC₀(k) of predicted sound to sound input to the prediction-mode combiner 132, in accordance with:

$${ICC}_{0} ( k ) = \frac{{e}_{l} ( k ) + {e}_{r} ( k ) + {e}_{c} ( k )}{{e}_{{L}_{i n}} ( k ) + {e}_{{R}_{i n}} ( k ) + {e}_{{C}_{i n}} ( k )} \\ {e}_{{L}_{i n}} ( k ) = {\sum }_{n = 0}^{N - 1} {\vert {L}_{i n} ( k , n ) \vert}^{2} \\ {e}_{{R}_{i n }} ( k ) = {\sum }_{n = 0}^{N - 1} {\vert {R}_{i n} ( k , n ) \vert}^{2} \\ {e}_{{C}_{i n}} ( k ) = {\sum }_{n = 0}^{N - 1} {\vert {C}_{i n} ( k , n ) \vert}^{2} \\ l ( k , n ) = \frac{1}{3} \{ ( {CPC}_{1} ( k ) + 2 ) \cdot {L}_{p 0} ( k , n ) + ( {CPC}_{2} ( k ) - 1 ) \cdot {R}_{p 0} ( k , n ) \} \\ r ( k , n ) = \frac{1}{3} \{ ( {CPC}_{1} ( k ) - 1 ) \cdot {L}_{p 0} ( k , n ) + ( {CPC}_{2} ( k ) + 2 ) \cdot {R}_{p 0} ( k , n ) \} \\ c ( k , n ) = \frac{1}{3 } \{ ( 1 - {CPC}_{1} ( k ) ) \sqrt{2} \cdot {L}_{p 0} ( k , n ) + ( 1 - {CPC}_{2} ( k ) ) \sqrt{2} \cdot {R}_{p 0} ( k , n ) \} \\ {e}_{l} ( k ) = {\sum }_{n = 0}^{N - 1} {\vert l ( k , n ) \vert}^{2} \\ {e}_{r} ( k ) = {\sum }_{n = 0}^{N - 1} {\vert r ( k , n ) \vert}^{2} \\ {e}_{c } ( k ) = {\sum }_{n = 0}^{N - 1} {\vert c ( k , n ) \vert}^{2} \qquad ( 12 )$$

where Lᵢₙ(k,n), Rᵢₙ(k,n), and Cᵢₙ(k,n) are the left-channel frequency signal, the right-channel frequency signal, and the center-channel frequency signal, respectively, generated by the first downmixer 12. Also, e_{Lin}(k), e_{Rin}(k), and e_{Cin}(k) are autocorrelation values of the left-channel frequency signal, the right-channel frequency signal, and the center-channel frequency signal, respectively, in the frequency band k. Further, l(k,n), r(k,n), and c(k,n) are estimated decoded signals of the left channel, the right channel, and the center channel, respectively, in the frequency band k, the signals being calculated using the prediction coefficients CPC₁(k) and CPC₂(k) and the stereo frequency signals Lₚ₀(k,n) and Rₚ₀(k,n). Further, eₗ(k), eᵣ(k), and e_{c}(k) are autocorrelation values of l(k,n), r(k,n), and c(k,n), respectively, in the frequency band k.

The prediction-mode combiner 132 outputs the stereo frequency signals Lₚ₀(k,n) and Rₚ₀(k,n) to the channel-signal encoder 17 via the selector 15. The prediction-mode combiner 132 also outputs the spatial information CPC₁(k), CPC₂(k), and ICC₀(k) to the spatial-information encoder 18 via the selector 15.

In accordance with a control signal from the determiner 16, the selector 14 passes the three-channel frequency signals, output from the first downmixer 12, to one of the energy-based-mode combiner 131 and the prediction-mode combiner 132 in the second downmixer 13.

In accordance with the control signal from the determiner 16, the selector 15 also passes the stereo frequency signals, output from one of the energy-based-mode combiner 131 and the prediction-mode combiner 132, to the channel-signal encoder 17. In accordance with the control signal from the determiner 16, the selector 15 also passes the spatial information, output from one of the energy-based-mode combiner 131 and the prediction-mode combiner 132, to the spatial-information encoder 18.

The determiner 16 selects, from the prediction mode and the energy-based mode, a spatial-information generation mode used in the second downmixer 13.

As described above, when two-channel signals to be downmixed have a high similarity and have a large phase difference, there is a possibility that the two-channel channels cancel each other out. Accordingly, on the basis of the three-channel frequency signals received from the first downmixer 12, the determiner 16 determines the similarity and the phase difference between two signals to be downmixed by the second downmixer 13. The determiner 16 then selects one of the prediction mode and the energy-based mode, depending on whether or not the similarity and the phase difference satisfy a determination condition that the amplitude of the stereo frequency signals generated by the downmixing is attenuated. To this end, the determiner 16 has a similarity calculator 161, a phase-difference calculator 162, and a control-signal generator 163.

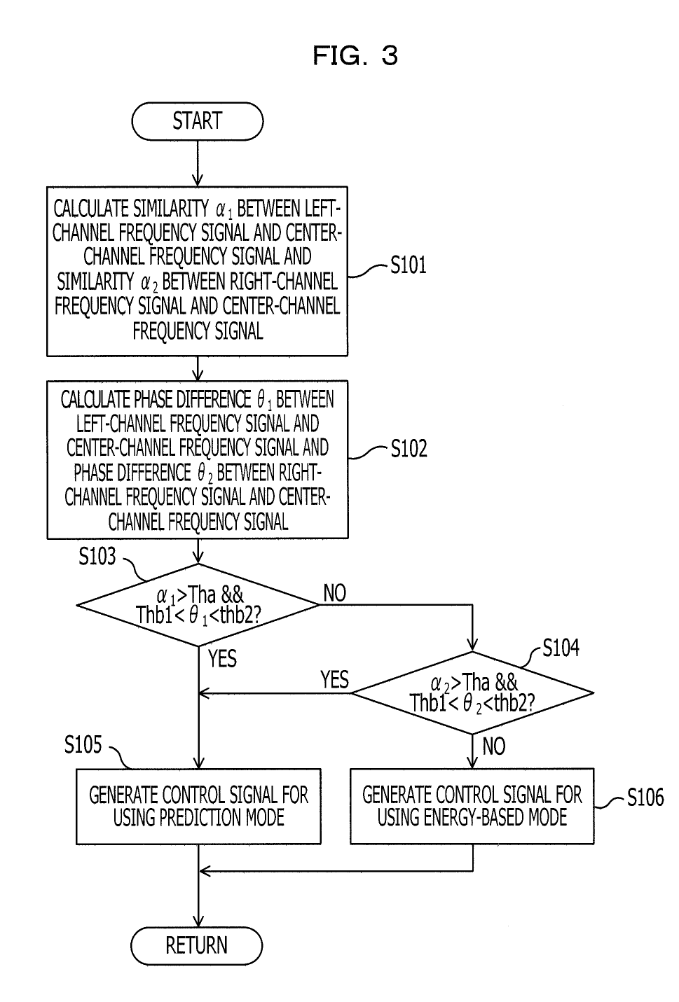

FIG. 3 is an operation flowchart of spatial-information generation-mode selection processing executed by the determiner 16. The determiner 16 performs the spatial-information generation-mode selection processing for each frame. In an embodiment, the second downmixer 13 generate stereo frequency signals by downmixing the left-channel frequency signal and the center-channel frequency signal and downmixing the right-channel frequency signal and the center-channel frequency signal. Thus, in operation S101, the similarity calculator 161 in the determiner 16 calculates a similarity α₁ between the left-channel frequency signal and the center-channel frequency signal and a similarity α₂ between the right-channel frequency signal and the center-channel frequency signal, in accordance with:

$${α}_{1} = \frac{\vert {e}_{LC} \vert}{\sqrt{{e}_{L} {e}_{C}}} , {α}_{2} = \frac{\vert {e}_{RC} \vert}{\sqrt{{e}_{R} {e}_{C}}} \\ {e}_{L} = {\sum }_{k = 0}^{K - 1} {\sum }_{n = 0}^{N - 1} {\vert {L}_{i n} ( k , n ) \vert}^{2} \\ {e}_{R} = {\sum }_{k = 0}^{K - 1} {\sum }_{n = 0}^{N - 1} {\vert {R}_{i n} ( k , n ) \vert}^{2} \\ {e}_{C} = {\sum }_{k = 0}^{K - 1} {\sum }_{n = 0}^{N - 1} {\vert {C}_{i n} ( k , n ) \vert}^{2} \\ {e}_{LC} = {{\sum }_{k = 0}}^{K - 1} {\sum }_{n = 0}^{N - 1} {L}_{i n} ( k , n ) \cdot {C}_{i n} ( k , n ) \\ {e}_{RC} = {\sum }_{k = 0}^{K - 1} {\sum }_{n = 0}^{N - 1} {R}_{i n} ( k , n ) \cdot {C}_{i n } ( k , n ) \qquad ( 13 )$$

where N is the number of sample points in a time direction which are included in one frame and is 128 in an embodiment. K is the total number of frequency bands and is 64 in an embodiment. Also, e_{L} is an autocorrelation value of the left-channel frequency signal Lᵢₙ(k,n) and e_{R} is an autocorrelation value of the right-channel frequency signal Rᵢₙ(k,n). In addition, e_{C} is an autocorrelation value of the center-channel frequency signal Cᵢₙ(k,n). Also, e_{LC} is a cross-correlation value between the left-channel frequency signal Lᵢₙ(k,n) and the center-channel frequency signal Cᵢₙ(k,n). In addition, e_{RC} is a cross-correlation value between the right-channel frequency signal Rᵢₙ(k,n) and the center-channel frequency signal Cᵢₙ(k,n).

The similarity calculator 161 outputs the similarities α₁ and α₂ to the control-signal generator 163.

In operation S102, the phase-difference calculator 162 in the determiner 16 calculates a phase difference θ₁ between the left-channel frequency signal and the center-channel frequency signal and a phase difference θ₂ between the right-channel frequency signal and the center-channel frequency signal, in accordance with:

$${θ}_{1} = ∠ {e}_{LC} = arctan ( \frac{Im ( {e}_{LC} )}{Re ( {e}_{LC} )} ) \\ {θ}_{2} = ∠ {e}_{RC} = arctan ( \frac{Im ( {e}_{RC} )}{Re ( {e}_{RC} )} ) \qquad ( 14 )$$

where Re(e_{LC}) indicates a real part of the cross-correlation value e_{LC}, Im(e_{LC}) indicates an imaginary part of the cross-correlation value e_{LC}, Re(e_{RC}) indicates a real part of the cross-correlation value e_{RC}, and Im(e_{RC}) indicates an imaginary part of the cross-correlation value e_{RC}.

The phase-difference calculator 162 outputs the phase differences θ₁ and θ₂ to the control-signal generator 163.

The control-signal generator 163 in the determiner 16 is one example of a control unit and determines whether or not the similarity α₁ and the phase difference θ₁ satisfy the determination condition that the left-side stereo signal frequency is attenuated. More specifically, in operation S103, the control-signal generator 163 determines whether or not the similarity α₁ between the left-channel frequency signal and the center-channel frequency signal is larger than a predetermined similarity threshold Tha and the phase difference θ₁ between the left-channel frequency signal and the center-channel frequency signal is in a predetermined phase-difference range (Thb1 to Thb2). When the similarity α₁ is larger than the similarity threshold Tha and the phase difference θ₁ is in the predetermined phase-difference range (i.e., Yes in operation S103), the determination condition is satisfied and the possibility that the left-channel frequency signal and the center-channel frequency signal cancel each other out is high. Accordingly, in operation S105, the control-signal generator 163 generates a control signal for the selectors 14 and 15 so as to cause the second downmixer 13 to use the prediction mode.

The similarity threshold Tha is set to, for example, a largest value (e.g., 0.7) of the similarity with which the listener does not perceive, when audio signals encoded using the spatial information generated in the energy-based mode are played back, deterioration of the sound quality of the audio signals. The predetermined phase-difference range is set to, for example, a largest range of the phase difference with which the listener perceives, when audio signals encoded using the spatial information generated in the energy-based mode are played back, deterioration of the sound quality of the audio signals. For example, the lower limit Thb1 is set to 0.89 π and the upper limit Thb2 is set to 1.11 π.

On the other hand, when the similarity α₁ is smaller than or equal to the similarity threshold Tha or the phase difference θ₁ is in not the predetermined phase-difference range (No in operation S103), the determination condition is satisfied and the possibility that the left-channel frequency signal and the center-channel frequency signal cancel each other out is low even when they are downmixed.

In this case, the control-signal generator 163 determines whether or not the similarity α₂ and the phase difference θ₂ satisfy a determination condition that the right-side stereo frequency signals are attenuated. More specifically, in operation S104, the control-signal generator 163 determines whether or not the similarity α₂ between the right-channel frequency signal and the center-channel frequency signal is larger than the predetermined similarity threshold Tha and the phase difference θ₂ between the right-channel frequency signal and the center-channel frequency signal is in the predetermined phase-difference range (Thb1 to Thb2). When the similarity α₂ is larger than the predetermined similarity threshold Tha and the phase difference θ₂ is in the predetermined phase-difference range (Yes in operation S104), the determination condition is satisfied and the possibility that the right-channel frequency signal and the center-channel frequency signal cancel each other out is high. Accordingly, in operation S105, the control-signal generator 163 generates a control signal for the selectors 14 and 15 so as to cause the second downmixer 13 to use the prediction mode.

On the other hand, when the similarity α₂ is smaller than or equal to the similarity threshold Tha or the phase difference θ₂ is not in the predetermined phase-difference range (No in operation S104), the determination condition is not satisfied and the possibility that the right-channel frequency signal and the center-channel frequency signal cancel each other out is low even when they are downmixed.

Accordingly, in operation S106, the control-signal generator 163 generates a control signal for the selectors 14 and 15 so as to cause the second downmixer 13 to use the energy-based mode.

Subsequent to operation S105 or S106, the control-signal generator 163 outputs the control signal to the selectors 14 and 15, and then the determiner 16 ends the spatial-information generation-mode selection processing.

As described above, when there is a possibility that at least one of the left-side channel signal and the right-side channel signal of the stereo frequency signals generated by downmixing is attenuated, the determiner 16 causes the second downmixer 13 to generate the spatial information in the prediction mode.

The determiner 16 may execute the processing in operation S101 and the processing in operation S102 in parallel or may interchange the order of the processing in operation S101 and the processing in operation S102. The determiner 16 may also interchange the order of the processing in operation S103 and the processing in operation S104.

The channel-signal encoder 17 receives the stereo frequency signals, output from the second downmixer 13, via the selector 15 and encodes the received stereo frequency signals. To this end, the channel-signal encoder 17 has an SBR encoder 171, a frequency-time transformer 172, and an AAC encoder 173.

Each time the SBR encoder 171 receives the stereo frequency signals, it encodes, for each channel, high-frequency range components (i.e., components contained in a high-frequency band) of the stereo frequency signals in accordance with SBR coding. As a result, the SBR encoder 171 generates an SBR code.

For example, as discussed in Japanese Unexamined Patent Application Publication No. 2008-224902, the SBR encoder 171 replicates low-frequency range components of frequency signals of the respective channels which are highly correlated with the high-frequency range components to be subjected to the SBR encoding. The low-frequency range components are components of frequency signals in the channels which are included in a low-frequency band that is lower than the high-frequency band including high-frequency range components to be encoded by the SBR encoder 171. The low-frequency range components are encoded by the AAC encoder 173. The SBR encoder 171 adjusts the power of the replicated high-frequency range components so that it matches the power of the original high-frequency range components. The SBR encoder 171 uses, as supplementary information, components that are included in the original high-frequency range components and that cannot be approximated by transposing the low-frequency range components because of a large difference from the low-frequency range components. The SBR encoder 171 then encodes information indicating a positional relationship between the low-frequency range components used for the replication and the corresponding high-frequency range components, the amount of power adjustment, and the supplementary information by performing quantization.

The SBR encoder 171 outputs the encoded information, i.e., the SBR code, to the multiplexer 19.

Each time the frequency-time transformer 172 receives the stereo frequency signals, it transforms the stereo frequency signals of the channels into time-domain stereo signals. For example, when the time-frequency transformer 11 employs a QMF bank, the frequency-time transformer 172 performs frequency-time transform on the stereo frequency signals of the channels by using a complex QMF bank expressed by:

$$IQMF ( k , n ) = \frac{1}{64} exp ( j \frac{π}{128} ( k + 0.5 ) ( 2 n - 255 ) ) , \\ 0 \leq k < 64 , 0 \leq n < 128 \qquad ( 15 )$$

where IQMF(k,n) indicates a complex QMF having variables of time n and a frequency k.

When the time-frequency transformer 11 employs other time-frequency transform processing, such as fast Fourier transform, discrete cosine transform, or modified discrete cosine transform, the frequency-time transformer 172 uses inverse transform of the time-frequency transform processing.

The frequency-time transformer 172 performs frequency-time transform on the frequency signals of the channels to obtain stereo signals of the channels and outputs the stereo signals to the AAC encoder 173.

Each time the AAC encoder 173 receives the stereo signals of the channels, it generates an AAC code by encoding low-frequency range components of the signals of the channels in accordance with AAC coding. The AAC encoder 173 may utilize, for example, the technology disclosed in Japanese Unexamined Patent Application Publication No. 2007-183528. More specifically, the AAC encoder 173 performs discrete cosine transform on the received stereo signals of the channels to re-generate the stereo frequency signals. The AAC encoder 173 determines perceptual entropy (PE) from the re-generated stereo frequency signals. The PE indicates the amount of information needed to quantize a corresponding noise block so that the listener does not perceive the noise. The PE has a characteristic of exhibiting a large value for sound whose signal level changes in a short period of time, such as percussive sound produced by a percussion instrument. The AAC encoder 173 shortens a window with respect to a frame with which the value of PE becomes relatively large and lengthens a window with respect to a block with which the value of PE becomes relatively small. For example, the short window includes 256 samples and the long window includes 2048 samples. By using a window having a determined length, the AAC encoder 173 executes modified discrete cosine transform (MDCT) on the stereo signals of the channels to thereby transform the stereo signals of the channels into a set of MDCT coefficients.

The AAC encoder 173 then quantizes the set of MDCT coefficients and performs variable-length coding on the set of quantized MDCT coefficients.

The AAC encoder 173 outputs the set of variable-length-coded MDCT coefficients and relevant information, such as quantization coefficients, to the multiplexer 19 as an AAC code.

The spatial-information encoder 18 encodes the spatial information, received from the first downmixer 12 and the second downmixer 13, to generate an MPEG Surround code (hereinafter referred to as “MPS code”).

The spatial-information encoder 18 refers to a quantization table indicating relationships between the values of the similarity in the spatial information and index values. By referring to the quantization table, the spatial-information encoder 18 determines the index value having a value closest to the similarity ICCᵢ(k) (i=L,R,0) with respect to each frequency band. The quantization table is pre-stored in a memory included in the spatial-information encoder 18.

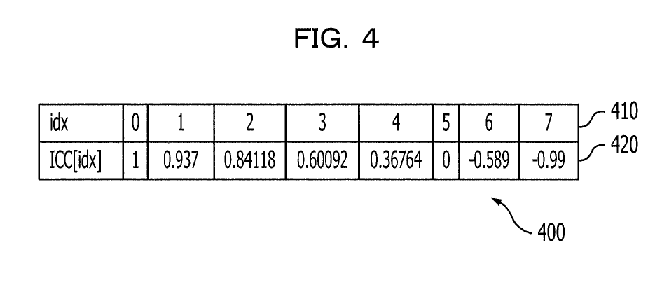

FIG. 4 illustrates one example of a quantization table for similarities. In a quantization table 400 illustrated in FIG. 4, fields in an upper row 410 indicate index values and fields in a lower row 420 indicate representative value of similarities associated with the index values in the same corresponding columns. The similarity can assume a value in the range of −0.99 to +1. For example, when the similarity for the frequency band k is 0.6, the representative value of the similarity corresponding to an index value of 3 in the quantization table 400 is the closest to the similarity for the frequency band k. Accordingly, the spatial-information encoder 18 sets the index value for the frequency band k to 3.

Next, with respect to each frequency band, the spatial-information encoder 18 determines a value of difference between the indices along the frequency direction. For example, when the index value for the frequency band k is 3 and the index value for a frequency band (k−1) is 0, the spatial-information encoder 18 determines that the index difference value for the frequency band k is 3.

The spatial-information encoder 18 refers to an encoding table indicating relationships between index-value difference values and similarity codes. By referring to the encoding table, the spatial-information encoder 18 determines a similarity code idxiccᵢ(k) (i=L,R,0) for the value of difference between the indices with respect to each frequency of a similarity ICCᵢ(k) (i=L,R,0). The encoding table is pre-stored in the memory included in the spatial-information encoder 18. The similarity code may be a variable-length code whose code length shortens for a difference value that appears more frequently. Examples of the variable-length code include a Huffman code and an arithmetic code.

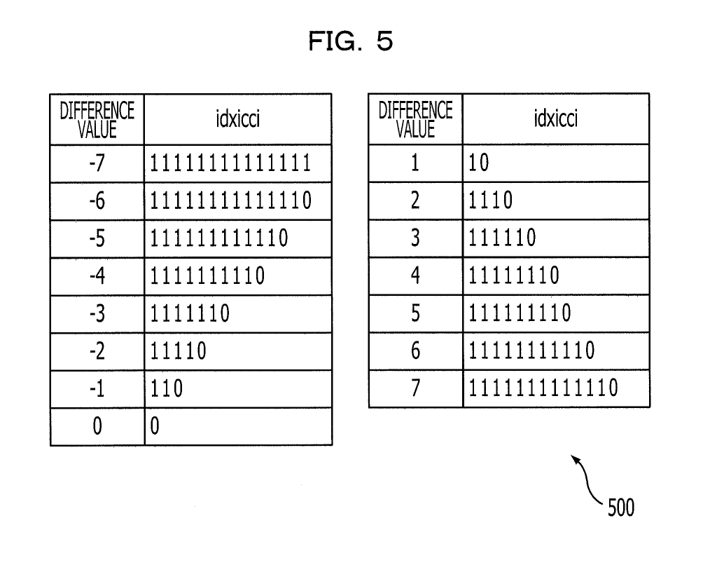

FIG. 5 illustrates one example of a table indicating relationships between index difference values and similarity codes. In this example, the similarity codes are Huffman codes. In an encoding table 500 illustrated in FIG. 5, fields in a left column indicate index difference values and fields in a right column indicate similarity codes associated with the index difference values in the same corresponding rows. For example, when the index difference value for the similarity ICC_{L}(k) for the frequency band k is 3, the spatial-information encoder 18 refers to the encoding table 500 to set a similarity code idxicc_{L}(k) for the similarity ICC_{L}(k) for the frequency band k to “111110”.

The spatial-information encoder 18 refers to a quantization table indicating relationships between the values of intensity differences and index values. By referring to the quantization table, the spatial-information encoder 18 determines the index value having a value closest to an intensity difference CLDⱼ(k) (j=L,R,C,1,2) with respect to each frequency band. Next, with respect to each frequency band, the spatial-information encoder 18 determines an index difference value along the frequency direction. For example, when the index value for the frequency band k is 2 and the index value for the frequency band (k−1) is 4, the spatial-information encoder 18 determines that the index difference value for the frequency band k is −2.

The spatial-information encoder 18 refers to an encoding table indicating relationships between index difference values and intensity-difference codes. By referring to the encoding table, the spatial-information encoder 18 determines an intensity-difference code idxcldⱼ(k) (j=L,R,C,1,2) for the difference value for each frequency band k for the difference value CLDⱼ(k). In this case, idxcld₁(k) and idxcld₂(k) are determined only when the spatial information for the stereo frequency signals is generated in the energy-based mode. Similarly to the similarity code, the intensity-difference code may be a variable-length code whose code length shortens for a difference value that appears more frequently. Examples of the variable-length code include a Huffman code and an arithmetic code.

The quantization table and the encoding table are pre-stored in the memory included in the spatial-information encoder 18.

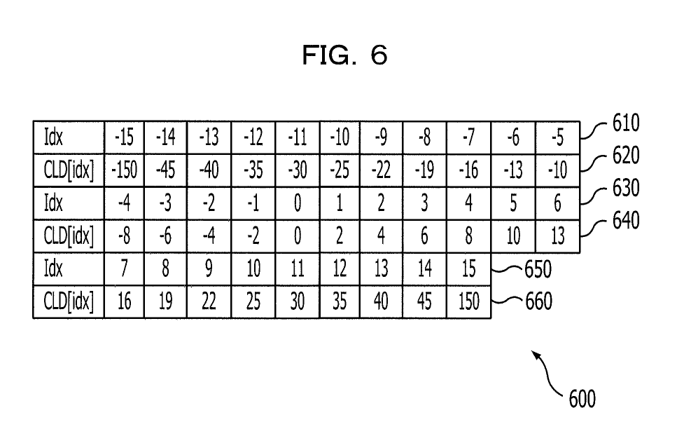

FIG. 6 illustrates one example of a quantization table for intensity differences. In a quantization table 600 illustrated in FIG. 6, fields in rows 610, 630, and 650 indicate index values and fields in rows 620, 640, and 660 indicate representative values of intensity differences associated with the index values indicated in the fields in the rows 610, 630, and 650 in the same corresponding columns.

For example, when an intensity difference CLD_{L}(k) for the frequency band k is 10.8 dB, the representative value of the intensity difference corresponding to an index value of 5 in the quantization table 600 is the closest to CLD_{L}(k). Thus, the spatial-information encoder 18 sets the index value for CLD_{L}(k) to 5.

In addition, when stereo frequency signals are generated in the prediction mode, the spatial-information encoder 18 refers to a quantization table indicating relationships between the prediction coefficients CPC₁(k) and CPC₂(k) and the index values. By referring to the quantization table, the spatial information encoder 18 determines the index value having a value closest to the prediction coefficients CPC₁(k) and CPC₂(k) with respect to each frequency band. With respect to each frequency band, the spatial information encoder 18 determines an index difference value along the frequency direction. For example, when the index value for the frequency band k is 2 and the index value for the frequency band (k−1) is 4, the spatial-information encoder 18 determines that the index difference value for the frequency band k is −2.

The spatial-information encoder 18 refers to an encoding table indicating relationships between the index difference values and prediction-coefficient codes. By referring to the encoding table, the spatial-information encoder 18 determines a prediction-coefficient code idxcpcₘ(k) (m=1,2) with respect to the difference value relative to the prediction coefficient CPCₘ(k) (m=1,2) each frequency band k. Similarly to the similarity codes, the prediction-coefficient code may be a variable-length code whose code length shortens for a difference value that appears more frequently. Examples of the variable-length code include a Huffman code and an arithmetic code.

The quantization table and the encoding table are pre-stored in the memory included in the spatial-information encoder 18.

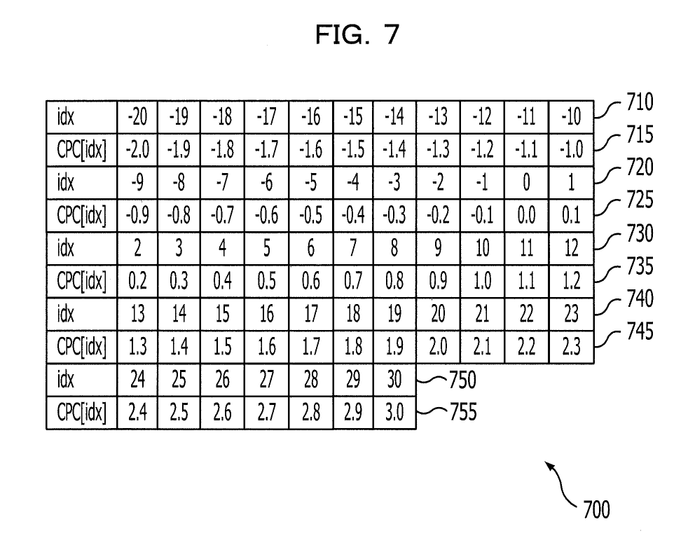

FIG. 7 illustrates one example of a quantization table for prediction coefficients. In a quantization table 700 illustrated in FIG. 7, fields in rows 710, 720, 730, 740, and 750 indicate index values. Fields in rows 715, 725, 735, 745, and 755 indicate representative values of prediction coefficients associated with the index values indicated in the fields in the rows 710, 720, 730, 740, and 750 in the same corresponding columns.

For example, when the prediction coefficient CPC₁(k) for the frequency band k is 1.21, the representative value of the prediction coefficient associated with an index value of 12 in the quantization table 700 is the closest to CPC₁(k). Accordingly, the spatial-information encoder 18 sets the index value for CPC₁(k) to 12.

The spatial-information encoder 18 generates an MPS code by using the similarity code idxiccᵢ(k), the intensity-difference code idxcldⱼ(k), and the prediction-coefficient code idxcpcₘ(k). For example, the spatial-information encoder 18 generates an MPS code by arranging the similarity code idxiccᵢ(k), the intensity-difference code idxcldⱼ(k), and the prediction-coefficient code idxcpcₘ(k) in a predetermined order. The predetermined order is described in, for example, ISO/IEC 23003-1:2007.

The spatial-information encoder 18 outputs the generated MPS code to the multiplexer 19.

The multiplexer 19 multiplexes the AAC code, the SBR code, and the MPS code by arranging the codes in a predetermined order. The multiplexer 19 then outputs the encoded audio signals generated by the multiplexing.

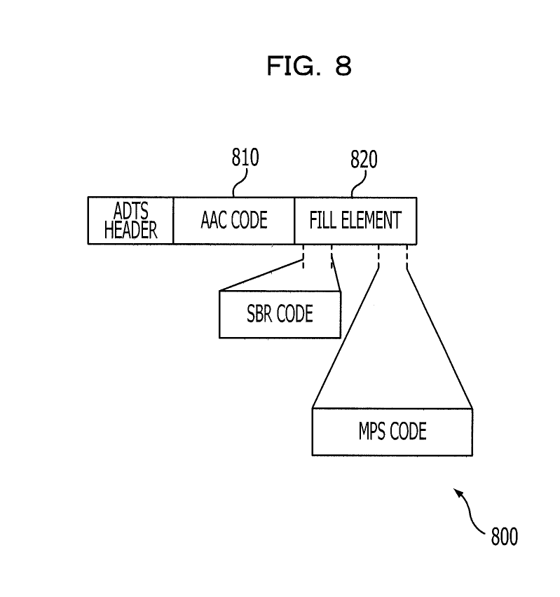

FIG. 8 illustrates one example of a format of data containing encoded audio signals. In this example, the encoded stereo signals are created according to an MPEG-4 ADTS (Audio Data Transport Stream) format.

In an encoded data string 800 illustrated in FIG. 8, the AAC code is contained in a data block 810. The SBR code and the MPS code are contained in part of the area of a block 820 in which a FILL element in the ADTS format is contained.

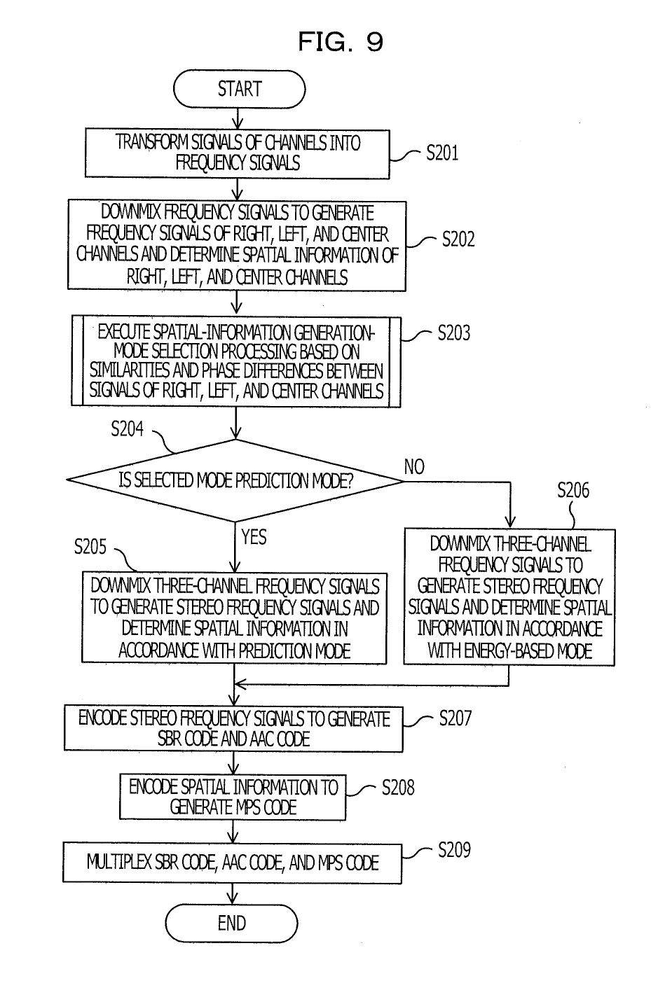

FIG. 9 is an operation flowchart of an audio encoding processing. The flowchart of FIG. 9 illustrates processing for multi-channel audio signals for one frame. The audio encoding device 1 repeatedly executes, for each frame, a procedure of the audio encoding processing illustrated in FIG. 9, while continuously receiving multi-channel audio signals.

In operation S201, the time-frequency transformer 11 transforms the signals of the respective channels into frequency signals. The time-frequency transformer 11 outputs the frequency signals of the channels to the first downmixer 12.

Next, in operation 5202, the first downmixer 12 downmixes the frequency signals of the channels to generate frequency signals of three channels, i.e., the right, left, and center channels. The frequency signals generated may also be of neighboring channels. The first downmixer 12 determines spatial information of each of the right, left, and center channels. The first downmixer 12 outputs the frequency signals of the three channels to the selector 14 and the determiner 16. The first downmixer 12 outputs the spatial information to the spatial-information encoder 18.

In operation S203, on the basis of the similarities and the phase differences between the signals of the right, left, and center channels, the determiner 16 executes spatial-information generation-mode selection processing. For example, the determiner 16 executes the spatial-information generation-mode selection processing in accordance with the operation flow illustrated in FIG. 3. The determiner 16 outputs a control signal corresponding to the selected spatial-information generation mode to the selectors 14 and 15.

In operation S204, depending on whether or not the selected mode is the prediction mode, the selectors 14 and 15 connect one of the energy-based-mode combiner 131 and the prediction-mode combiner 132 to the first downmixer 12 and also to the channel-signal encoder 17 and the spatial-information encoder 18. When the selected mode is the prediction mode (Yes in operation S204), the selector 14 outputs the three-channel frequency signals, received from the first downmixer 12, to the prediction-mode combiner 132 in the second downmixer 13.

In operation S205, the prediction-mode combiner 132 downmixes the three-channel frequency signals to generate stereo frequency signals. The prediction-mode combiner 132 also determines spatial information in accordance with the prediction mode. The prediction-mode combiner 132 outputs the stereo frequency signals to the channel-signal encoder 17 via the selector 15. The prediction-mode combiner 132 outputs the spatial information to the spatial-information encoder 18 via the selector 15.

On the other hand, when the selected mode is the energy-based mode (No in operation S204), the selector 14 outputs the three-channel frequency signals, received from the first downmixer 12, to the energy-based-mode combiner 131 in the second downmixer 13.

In operation S206, the energy-based-mode combiner 131 downmixes the three-channel frequency signals to generate stereo frequency signals. The energy-based-mode combiner 131 also determines spatial information in accordance with the energy-based mode. The energy-based-mode combiner 131 outputs the stereo frequency signals to the channel-signal encoder 17 via the selector 15. The energy-based-mode combiner 131 also outputs the spatial information to the spatial-information encoder 18 via the selector 15.

Subsequent to operation S205 or S206, in operation S207, the channel-signal encoder 17 performs SBR encoding on high-frequency range components of the received multi-channel stereo frequency signals. The channel-signal encoder 17 also performs AAC encoding on, of the received multi-channel stereo frequency signals, low-frequency range components that are not SBR-encoded.

The channel-signal encoder 17 outputs an SBR code, such as information indicating positional information of high-frequency range components corresponding to low-frequency range components used for the replication, and an AAC code to the multiplexer 19.

In operation S208, the spatial-information encoder 18 encodes the received spatial information to generate an MPS code. The spatial-information encoder 18 then outputs the generated MPS code to the multiplexer 19.

Lastly, in operation S209, the multiplexer 19 multiplexes the generated SBR code, AAC code, and MPS code to generate encoded audio signals.

The multiplexer 19 outputs the encoded audio signals. Thereafter, the audio encoding device 1 ends the encoding processing.

The audio encoding device 1 may also execute the processing in operation S207 and the processing in operation S208 in parallel. Alternatively, the audio encoding device 1 may execute the processing in operation S208 prior to the processing in operation S207.

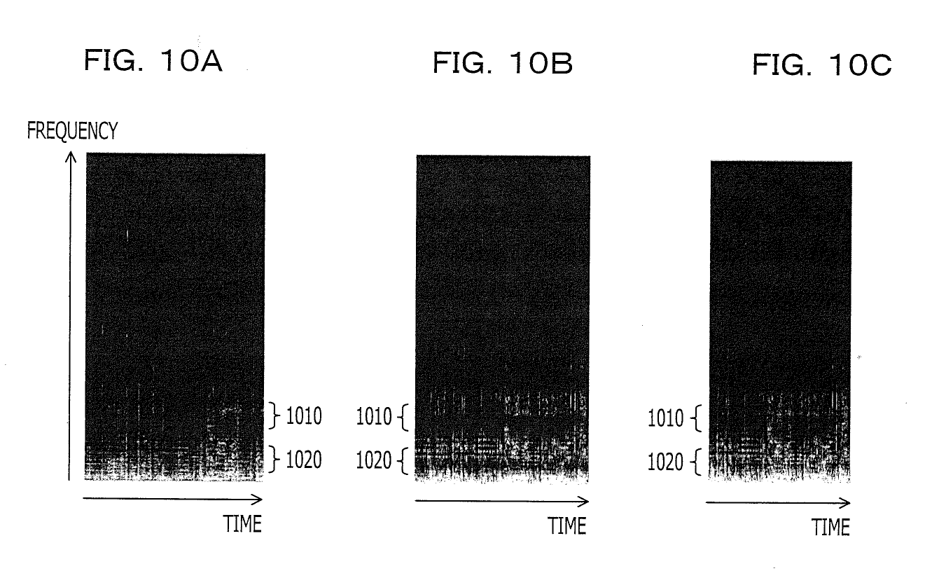

FIG. 10A illustrates one example of a center-channel signal of original multi-channel audio signals resulting from recording of sound at a concert. FIG. 10B illustrates one example of a center-channel playback signal decoded using spatial information generated in the energy-based mode during encoding of the original multi-channel audio signals. FIG. 10C illustrates one example of a center-channel playback signal of the multi-channel audio signals encoded by the audio encoding device 1 according to an embodiment.

In FIGS. 10A, 10B and 10C, the horizontal axis indicates time and the vertical axis indicates frequency. Each bright line indicates the center-channel signal. The brighter the bright line is, the stronger the center-channel signal is.

In FIG. 10A, signals having a certain intensity level are intermittently observed in frequency bands 1010 and 1020. In FIG. 10B, however, the intensity of the signals in the frequency bands 1010 and 1020 are apparently reduced compared to the intensity of the original center-channel signal. The playback sound in this case, therefore, is the so-called “muffled sound”, and the quality of the playback sound deteriorates from the original audio quality to a degree perceivable by the listener.

In contrast, in FIG. 10C, signals having an intensity that is close to that of the original signals are observed in the frequency bands 1010 and 1020. Thus, the quality of the playback sound in this case is higher than the quality of the playback sound of the signal illustrated in FIG. 10B. It can, therefore, be understood that decoding of multi-channel audio signals encoded by the audio encoding device 1 makes it possible to reproduce the original multi-channel audio signals in a favorable manner.

Table 1 illustrates encoding bitrates for spatial information for the multi-channel audio signals illustrated in FIG. 10A.

TABLE 1

| | Encoding Bitrate (kbps) |
|---|---|
| | for Spatial Information |
| Energy-based Mode Only | 12.0 |
| Prediction Mode Only | 15.0 |
| Energy-based Mode/Prediction Mode | 13.5 |

In Table 1, the left column indicates the spatial-information generation mode used for generating the spatial information during generation of stereo frequency signals. Each of the rows indicates an encoding bitrate for the spatial information when the multi-channel audio signals are encoded in the spatial-information generation mode indicated in the left field in the row. The “energy-based mode/prediction mode” illustrated in the bottom row indicates that the encoding is performed by the audio encoding device 1. As illustrated in Table 1, the encoding bitrate of the audio encoding device 1 is higher than the encoding bitrate when only the energy-based mode is used and can also be set lower than the encoding bitrate when only the prediction mode is used.

As described above, during generation of stereo frequency signals from frequency signals of three channels, the audio encoding device 1 selects the spatial-information generation mode in accordance with the similarity and the phase difference between two frequency signals to be downmixed. Thus, the audio encoding device 1 can use the prediction mode with respect to only multi-channel audio signals of sound recorded under a certain condition in which signals are attenuated by downmixing and can use, otherwise, the energy-based mode in which the compression efficiency is higher than that in the prediction mode. Since the audio encoding device can thus appropriately select the spatial-information generation mode, it is possible to reduce the amount of data of multi-channel audio signals to be encoded, while suppressing deterioration of the sound quality of the multi-channel audio signals to be played back.

The present invention is not limited to the above-described embodiments. According to another embodiment, by using the phase differences θ₁ and θ₂ determined by the phase-difference calculator 162, the similarity calculator 161 in the determiner 16 may perform correction so that the phases of the left-channel frequency signal Lᵢₙ(k,n) and the right-channel frequency signal Rᵢₙ(k,n) match the phase of the center-channel frequency signal Cᵢₙ(k,n). The similarity calculator 161 may then calculate the similarities α₁ and α₂ by using phase-corrected left-channel and right-channel frequency signals L′ᵢₙ(k,n) and R′ᵢₙ(k,n).

In this case, the similarity calculator 161 calculates the similarities α₁ and α₂ by inputting, instead of Lᵢₙ(k,n) and Rᵢₙ(k,n) in equation (13) noted above, the phase-corrected left-channel and right-channel frequency signals L′in(k,n) and R′in(k,n) determined according to:

L′ᵢₙ(k,n)=L(k,n)exp(jθ₁)

R′ᵢₙ(k,n)=R(k,n)exp(jθ₂) (16)

In an embodiment, in the operation flow of the spatial-information generation-mode selection processing illustrated in FIG. 3, the processing in operation S102 in which the phase differences are calculated is executed prior to the processing in operation S101 in which the similarities are calculated.

Since the similarity calculator 161 can cancel the frequency-signal differences due to a phase shift between the center channel and the left or right channel by using the left-channel and right-channel frequency signals phase-corrected as described above. Thus, it is possible to more accurately calculate the similarity.

According to another embodiment, the similarity calculator 161 in the determiner 16 may determine, for each frequency band, the similarity between the frequency signal of the left channel or the right channel and the frequency signal of the center channel. Similarly, the phase-difference calculator 162 in the determiner 16 may calculate, for each frequency band, the phase difference between the frequency signal of the left channel or the right channel and the frequency signal of the center channel. In this case, for each frequency band, the control-signal generator 163 in the determiner 16 determines whether or not the similarity and the phase difference satisfy the determination condition that the stereo frequency signals generated by downmixing are attenuated. When the similarity and the phase difference in any of the frequency bands satisfies the determination condition, the control-signal generator 163 generates a control signal for causing the second downmixer 13 to generate spatial information in the prediction mode. On the other hand, when the determination condition is not satisfied in all of the frequency bands, the control-signal generator 163 generates a control signal for causing the second downmixer 13 to generate spatial information in the energy-based mode.

In this case, for example, the similarity calculator 161 calculates, for each frequency band, a similarity α₁ (k) between the frequency signal of the left channel and the frequency signal of the center channel and a similarity α₂(k) between the frequency signal of the right channel and the frequency signal of the center channel, in accordance with:

$${α}_{1} ( k ) = \frac{\vert {e}_{LC} ( k ) \vert}{\sqrt{{e}_{L} ( k ) {e}_{C} ( k )}} , \\ {α}_{2} ( k ) = \frac{\vert {e}_{RC} ( k ) \vert}{\sqrt{{e}_{R} ( k ) {e}_{C} ( k )}} \\ ( k = 0 , 1 , … , K - 1 ) \\ {e}_{L} ( k ) = {\sum }_{n = 0}^{N - 1} {\vert {L}_{in} ( k , n ) \vert}^{2} \\ {e}_{R} ( k ) = {\sum }_{n = 0}^{N - 1} {\vert {R}_{in} ( k , n ) \vert}^{2} \\ {e}_{C} ( k ) = {\sum }_{n = 0}^{N - 1} {\vert {C}_{in} ( k , n ) \vert}^{2} \\ {e}_{LC} ( k ) = {\sum }_{n = 0}^{N - 1} {L}_{in} ( k , n ) \cdot {C}_{in} ( k , n ) \\ {e}_{RC} ( k ) = {\sum }_{n = 0}^{N - 1} {R}_{in} ( k , n ) \cdot {C}_{in} ( k , n ) \qquad ( 17 )$$

where e_{L}(k), e_{R}(k), and e_{C}(k) are an autocorrelation value of the left-channel frequency signal Lᵢₙ(k,n), an autocorrelation value of the right-channel frequency signal Rᵢₙ(k,n), and an autocorrelation value of the center-channel frequency signal Cᵢₙ(k,n), respectively, in the frequency band k. Also, e_{LC}(k) is a cross-correlation value between the left-channel frequency signal Lᵢₙ(k,n) and the center-channel frequency signal Cᵢₙ(k,n) in the frequency band k. Further, e_{RC}(k) is a cross-correlation value between the right-channel frequency signal Rᵢₙ(k,n) and the center-channel frequency signal Cᵢₙ(k,n) in the frequency band k.

The phase-difference calculator 162 calculates, for each frequency band, a phase difference θ₁(k) between the left-channel frequency signal and the center-channel frequency signal and a phase difference θ₂(k) between the right-channel frequency signal and the center-channel frequency signal, in accordance with:

$${θ}_{1} ( k ) = ∠ {e}_{LC} ( k ) = arctan ( \frac{Im ( {e}_{LC} ( k ) )}{Re ( {e}_{LC} ( k ) )} ) \\ {θ}_{2} ( k ) = ∠ {e}_{RC} ( k ) = arctan ( \frac{Im ( {e}_{RC} ( k ) )}{Re ( {e}_{RC} ( k ) )} ) \\ ( k = 0 , 1 , … , K - 1 ) \qquad ( 18 )$$

where Re(e_{LC}(k)) indicates a real part of the cross-correlation value e_{LC}(k), Im(e_{LC}(k)) indicates an imaginary part of the cross-correlation value e_{LC}(k), Re(e_{RC}(k)) indicates a real part of the cross-correlation value e_{RC}(k), and Im(e_{RC}(k)) indicates an imaginary part of the cross-correlation value e_{RC}(k).

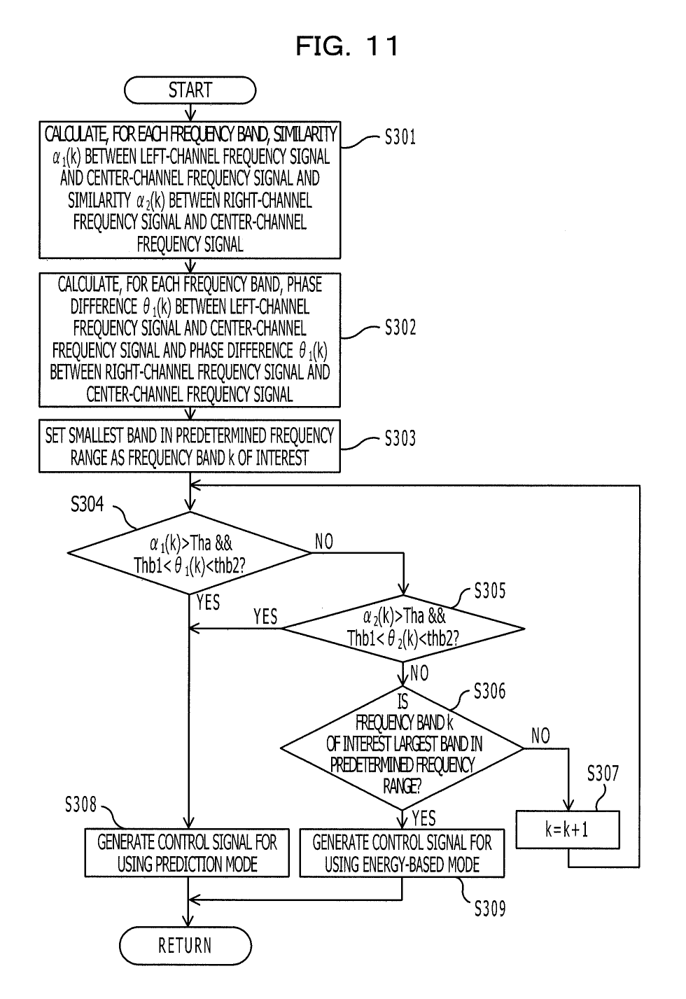

FIG. 11 is an operation flowchart of a spatial-information generation-mode selection processing in an embodiment. In operation S301, the similarity calculator 161 calculates, for each frequency band, a similarity α₁(k) between the left-channel frequency signal and the center-channel frequency signal and a similarity α₂(k) between the right-channel frequency signal and the center-channel frequency signal. The similarity calculator 161 outputs the similarities α₁(k) and α₂(k) to the control-signal generator 163.

In operation S302, the phase-difference calculator 162 calculates, for each frequency band, a phase difference α₁(k) between the left-channel frequency signal and the center-channel frequency signal and a phase difference α₂(k) between the right-channel frequency signal and the center-channel frequency signal. The phase-difference calculator 162 outputs the phase differences α₁(k) and α₂(k) to the control-signal generator 163.

In operation S303, the control-signal generator 163 sets a smallest frequency band in a predetermined frequency range as the frequency band k of interest.

In operation S304, the control-signal generator 163 determines whether or not the similarity α₁(k) between the left-channel frequency signal and the center-channel frequency signal in the frequency band k of interest is larger than a similarity threshold Tha and the phase difference α₁(k) between the left-channel frequency signal and the center-channel frequency signal is in a predetermined phase-difference range (Thb1 to Thb2). When the similarity α₁(k) is larger than the similarity threshold Tha and the phase difference θ₁(k) is in the phase-difference range (Thb1 to Thb2) (i.e., Yes in operation S304), the possibility that the left-channel frequency signal and the center-channel frequency signal cancel each other out is high. Accordingly, in operation S308, the control-signal generator 163 generates a control signal for the selectors 14 and 15 so as to cause the second downmixer 13 to use the prediction mode.

The similarity threshold Tha is set to, for example, 0.7, similarity to the similarity threshold in the above-described embodiment. The phase-difference range is also set, similarity to the phase-difference range in the above-described embodiment. For example, the lower limit Thb1 of the phase-difference range is set to 0.89 π and the upper limit Thb2 of the phase-difference range is set to 1.11 π.

On the other hand, when the similarity α₁(k) is smaller than or equal to the similarity threshold Tha or the phase difference θ₁(k) is not in the phase-difference range (i.e., No in operation S304), the possibility that the left-channel frequency signal and the center-channel frequency signal cancel each other out is low even when they are downmixed.

In this case, in operation S305, the control-signal generator 163 determines whether or not the similarity α₂(k) between the right-channel frequency signal and the center-channel frequency signal in the frequency band k of interest is larger than the similarity threshold Tha and the phase difference θ₂(k) between the right-channel frequency signal and the center-channel frequency signal is in the phase-difference range. When the similarity α₂(k) is larger than the similarity threshold Tha and the phase difference θ₂(k) is in the phase-difference range (i.e., Yes in operation S305), the possibility that the right-channel frequency signal and the center-channel frequency signal cancel each other out is high. Accordingly, in operation S308, the control-signal generator 163 generates a control signal for the selectors 14 and 15 so as to cause the second downmixer 13 to use the prediction mode.

On the other hand, when the similarity α₂(k) is smaller than or equal to the similarity threshold Tha or the phase difference θ₂(k) is not in the phase-difference range (i.e., No in operation S305), the possibility that the right-channel frequency signal and the center-channel frequency signal cancel each other out is low even when they are downmixed.

In this case, in operation S306, the control-signal generator 163 determines whether or not the frequency band k of interest is a largest frequency band in the predetermined frequency range. When the frequency band k of interest is not a largest frequency band in the predetermined frequency range (No in operation S306), the process proceeds to operation S307 in which the control-signal generator 163 changes the frequency band of interest to a next larger frequency band. Thereafter, the control-signal generator 163 repeatedly performs the processing in operation S304 and the subsequent operations.

On the other hand, when the frequency band k of interest is a largest frequency band in the predetermined frequency range (Yes in operation S306), the determination conditions in operations S304 and S305 for selecting the prediction mode are not satisfied with respect to all of the frequency bands.

Accordingly, in operation S309, the control-signal generator 163 generates a control signal for the selectors 14 and 15 so as to cause the second downmixer 13 to use the energy-based mode.

Subsequent to operation S308 or S309, the control-signal generator 163 outputs the control signal to the selectors 14 and 15. Thereafter, the determiner 16 ends the spatial-information generation-mode selection processing.

The determiner 16 may execute the processing in operation S301 and the processing in operation S302 in parallel or may interchange the order of the processing in operation S301 and the processing in operation S302. The determiner 16 may also interchange the order of the processing in operation S304 and the processing in operation S305.

The predetermined frequency range may be set so as to include all frequency bands in which the frequency signals of the respective channels are generated. Alternatively, the predetermined frequency range may be set so as to include only a frequency band (e.g., 0 to 9000 Hz or 20 to 9000 Hz) in which deterioration of the audio quality is easily perceivable by the listener.

According to an embodiment, for each frequency band, the audio encoding device 1 checks the possibility of signal attenuation due to downmixing, as described above. Thus, even when signal attenuation occurs in only one of the frequency bands, the audio encoding device 1 can appropriately select the spatial-information generation mode.

According to a modification, when the determination condition in operation S304 or S305 is satisfied in two or more predetermined frequency bands, the control-signal generator 163 may generate a control signal for the selectors 14 and 15 so as to cause the second downmixer 13 to use the prediction mode.

Alternatively, for each frequency band, the control-signal generator 163 may pre-set a weighting factor according to human hearing characteristics. The weighting factor is set to, for example, a value between 0 and 1. A larger value is set for the weighting factor for a frequency band in which deterioration of the audio quality is easily perceivable.

The control-signal generator 163 determines whether or not the determination condition in operation S304 or S305 is satisfied with respect to each of the frequency bands in the predetermined frequency range. The control-signal generator 163 then determines the total value of weighting factors set for the frequency bands in which the determination condition in operation S304 or S305 is satisfied. Only when the total value exceeds a predetermined threshold (e.g., 1 or 2), the control-signal generator 163 causes the second downmixer 13 to generate spatial information in the prediction mode.

According to the modification, by using the phase difference calculated by the phase-difference calculator 162 for each frequency band, the similarity calculator 161 may correct the phases of the left-channel and right-channel frequency signals so as to cancel the phase difference between the phases of the left-channel and right-channel frequency signals and the phase of the center-channel frequency signal. The similarity calculator 161 may then determine a similarity by using the left-channel and right-channel frequency signals phase-corrected for each frequency band.

According to still another embodiment, the determiner 16 may calculate the similarity and the phase difference between two signals to be downmixed, on the basis of time signals of the left, right, and center channels.

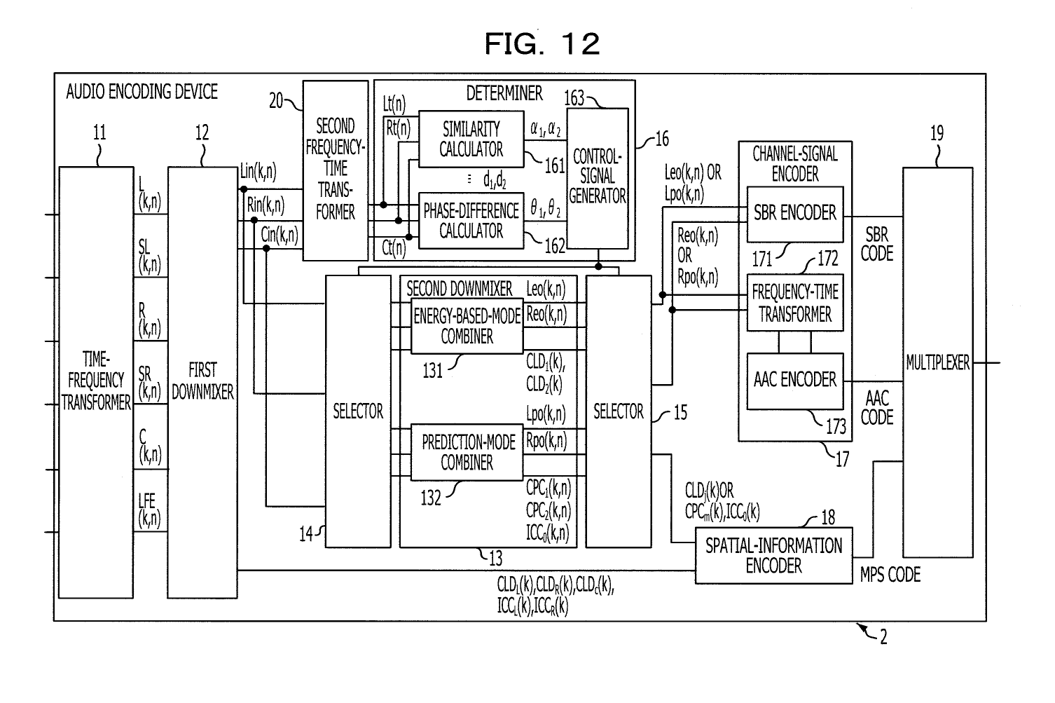

FIG. 12 is a schematic block diagram of an audio encoding device according to an embodiment. Elements included in an audio encoding device 2 illustrated in FIG. 12 are denoted by the same reference numerals as those of the corresponding elements included in the audio encoding device 1 illustrated in FIG. 1. The audio encoding device 2 is different from the audio encoding device 1 in that a second frequency-time transformer 20 is provided. A description below will be given of the second frequency-time transformer 20 and relevant units. For other points of the audio encoding device 2, reference is to be made to the above description of the audio encoding device 1.

Each time second frequency-time transformer 20 receives frequency signals of three channels, specifically, the left, right, and center channels, from the first downmixer 12, the second frequency-time transformer 20 transforms the frequency signals of the channels into time-domain signals. For example, when the time-frequency transformer 11 employs a QMF bank, the second frequency-time transformer 20 uses the complex QMF bank, expressed by equation (15) noted above, to transform the frequency signals of the channels into time signals.

When the time-frequency transformer 11 employs other time-frequency transform processing, such as fast Fourier transform, discrete cosine transform, or modified discrete cosine transform, the second frequency-time transformer 20 uses inverse transform of the time-frequency transform processing.

The second frequency-time transformer 20 performs the frequency-time transform on the frequency signals of the left, right, and center channels and outputs the resulting time signals of the channels to the determiner 16.

The similarity calculator 161 in the determiner 16 calculates a similarity α₁(d) when the time signal of the left channel and the time signal of the center channel are shifted by an amount corresponding to the number “d” of sample points, in accordance with equation (19) below. Similarly, the similarity calculator 161 calculates a similarity α₂(d) when the time signal of the right channel and the time signal of the center channel are shifted by an amount corresponding to the number “d” of sample points, in accordance with:

$$\begin{matrix}{α}_{1} ( d ) = \frac{{\sum }_{n = 0}^{N - 1} \vert {C}_{t} ( n ) \cdot {L}_{t} ( n + d ) \vert}{\sqrt{{\sum }_{n = 0}^{N - 1} {{L}_{t} ( n + d )}^{2} {\sum }_{n = 0}^{N - 1} {{C}_{t} ( n )}^{2}}} & - D \leq d \leq D\end{matrix} \\ \begin{matrix}{α}_{2} ( d ) = \frac{{\sum }_{n = 0}^{N - 1} \vert {C}_{t} ( n ) \cdot {R}_{t} ( n + d ) \vert}{\sqrt{{\sum }_{n = 0}^{N - 1} {{R}_{t} ( n + d )}^{2} {\sum }_{n = 0}^{N - 1} {{C}_{t} ( n )}^{2}}} & - D \leq d \leq D\end{matrix} \qquad ( 19 )$$

where Lₜ(n), Rₜ(n), and Cₜ(n) are the left-channel time signal, the right-channel time signal, and the center-channel time signal, respectively. N is the number of sample points in the time direction which are included in one frame. D is the number of sample points which corresponds to a largest value of the amount of shift between two time signals. D is set to, for example, the number of sample points (e.g., 128) corresponding to one frame.

The similarity calculator 161 calculates the similarities α₁(d) and α₂(d) with respect to the value of d, while varying d from −D to D. The similarity calculator 161 then uses a maximum value α₁ₘₐₓ(d) of α₁(d) as the similarity α₁ between the left-channel time signal and the center-channel time signal. Similarly, the similarity calculator 161 uses a maximum value α₂ₘₐₓ(d) of α₂(d) as the similarity α₂ between the right-channel time signal and the center-channel time signal.

The similarity calculator 161 outputs the similarities α₁ and α₂ to the control-signal generator 163. The similarity calculator 161 also passes, to the phase-difference calculator 162 in the determiner 16, the amount of shift d₁ at the sample point corresponding to α₁ₘₐₓ(d) and the amount of shift d₂ at the sample point corresponding to α₂ₘₐₓ(d).

The phase-difference calculator 162 uses, as the phase difference between the left-channel time signal and the center-channel time signal, the amount of shift d₁ at the sample point corresponding to the maximum value α₁ₘₐₓ(d) of the similarity between the left-channel time signal and the center-channel time signal. The phase-difference calculator 162 uses, as the phase difference between the right-channel time signal and the center-channel time signal, the amount of shift d₂ at the sample point corresponding to the maximum value α₂ₘₐₓ(d) of the similarity between the right-channel time signal and the center-channel time signal.

The phase-difference calculator 162 outputs d₁ and d₂ to the control-signal generator 163.

The determiner 16 selects the spatial-information generation mode used for generating stereo-frequency signals, in accordance with an operation flow that is similar to the operation flow of the spatial-information generation-mode selection processing illustrated in FIG. 3 and on the basis of the similarities α₁ and α₂ and the phase differences d₁ and d₂. During the selection, the control-signal generator 163 uses d₁ and d₂, instead of the phase differences θ₁ and θ₂, in operations S103 and S104 in the operation flowchart of the spatial-information generation-mode selection processing illustrated in FIG. 3. In this case, each of d₁ and d₂ indicates the number of sample points corresponding to the time difference between signals of two channels when the signals of the two channels have a largest similarity, and indirectly represents a phase difference. Thus, the larger d₁ and d₂ are, the larger the phase difference between the signals of two channels which are to be downmixed. Accordingly, in operation S103, the control-signal generator 163 determines whether or not the absolute value |d₁| of d₁ with respect to the phase difference is larger than a threshold Thc. The threshold Thc is set to, for example, a largest value of the amount of shift at the sample point with which the listener does not perceive, when audio signals encoded using the spatial information generated in the energy-based mode are played back, deterioration of the sound quality of the audio signals. For example, when the number of sample points for one frame is 128, the threshold Thc is set to 5 to 25. The similarity threshold Tha is set to, for example, 0.7, as in the above-described embodiment.

When α₁ is larger than the similarity threshold Tha and |d₁| is larger than the threshold Thc or when α₂ is larger than the similarity threshold Tha and |d₂| is larger than the threshold Thc, the control-signal generator 163 generates a control signal for selecting the prediction mode. Otherwise, the control-signal generator 163 generates a control signal for selecting the energy-based mode. By transmitting the control signal to the selectors 14 and 15, the control-signal generator 163 causes the second downmixer 13 to generate spatial information in the selected mode.

According to a modification of the audio encoding device 2, the phase-difference calculator 162 estimates frequency bands in which signals are likely to be attenuated by downmixing, on the basis of the values of d₁ and d₂. In accordance with the number of frequency bands and the similarities, the determiner 16 selects one of the energy-based mode and the prediction mode.

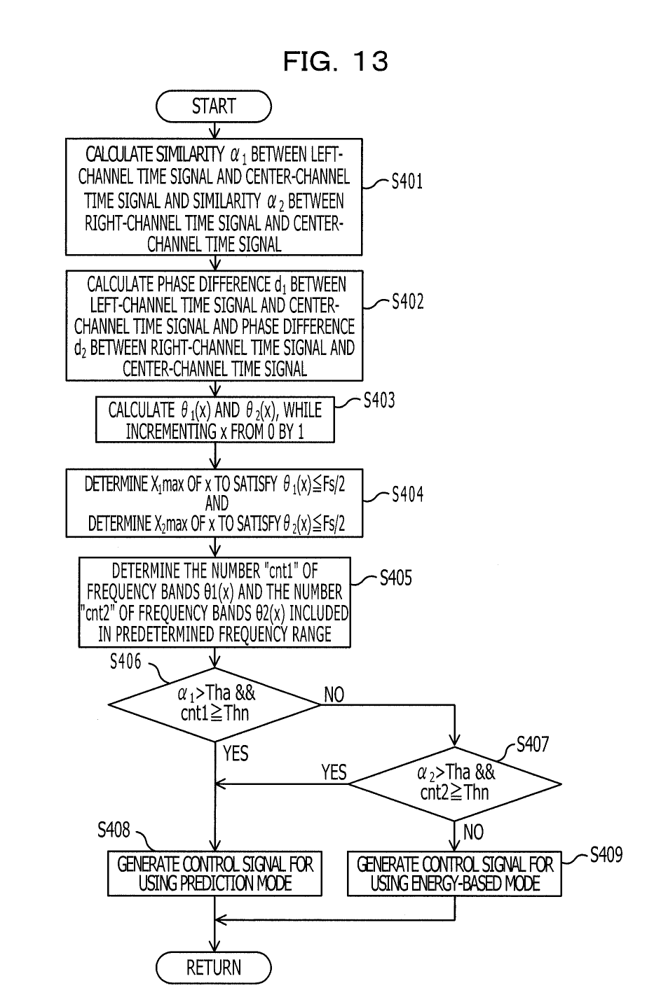

FIG. 13 is an operation flowchart of spatial-information generation-mode selection processing according to the modification of the audio encoding device 2. In operation S401, the similarity calculator 161 determines a similarity α₁ between the left-channel time signal and the center-channel time signal and a similarity α₂ between the right-channel time signal and the center-channel time signal. The similarity calculator 161 outputs the similarities α₁ and α₂ to the control-signal generator 163. The similarity calculator 161 outputs, to the phase-difference calculator 162, the number “d₁” of sample points corresponding to the amount of shift between the left-channel time signal and the center-channel time signal and the number “d₂” of sample points corresponding to the amount of shift between the right-channel time signal and the center-channel time signal. The number “d₁” corresponds to the similarity α₁ and the number “d₂” corresponds to the similarity α₂.

In operation S402, the phase-difference calculator 162 uses the number “d₁” of sample points as the phase difference between the left-channel time signal and the center-channel time signal. The phase-difference calculator 162 uses the number “d₂” of sample points as the phase difference between the right-channel time signal and the center-channel time signal.

Next, in operation S403, while incrementing x from 0 by 1, the phase-difference calculator 162 calculates frequency bands θ₁(x) and θ₂(x) in which signals are likely to be attenuated by downmixing, in accordance with:

$${θ}_{1} ( χ ) = \frac{( 2 χ + 1 )}{2} , \frac{Fs}{{d}_{i}} χ \geq 0 , l = 1 , 2 \\ {θ}_{1} ( χ ) \leq Fs / 2 \qquad ( 20 )$$

where Fs indicates a sampling frequency, θ₁(x) indicates a frequency band in which signals are likely to be attenuated by downmixing the left and center channels, and θ₂(x) indicates a frequency band in which signals are likely to be attenuated by downmixing the right and center channels. In this case, θ₁(x) and θ₂(x) are smaller than or equal to Fs/2. Also, x is an integer greater than or equal to 0 and dᵢ(i=1,2) indicates the number of sample points which corresponds to the phase difference. Thus, equation (20) yields a frequency band in which the left-channel or right-channel signal and the center-channel signal have a large phase difference and thus can cancel each other out.

As described above, the phase-difference calculator 162 calculates θ₁(x) and θ₂(x) while incrementing x from 0 by 1. Next, in operation S404, the phase-difference calculator 162 sets, as X₁max, the value of x when θ₁(x) reaches a maximum value that is smaller than or equal to Fs/2. Similarly, the phase-difference calculator 162 sets, as X₂max, the value of x when θ₂(x) reaches a maximum value that is smaller than or equal to Fs/2. That is, the frequency bands θ₁(x) determined according to expression (20) while x is varied from 0 to X₁ max are frequency bands in which signals are likely to be attenuated by downmixing the signals of the left and center channels. Similarly, the frequency bands θ₂(x) determined according to expression (20) while x is varied from 0 to X₂max are frequency bands in which signals are likely to be attenuated by downmixing the signals of the right and center channels.

The phase-difference calculator 162 outputs the frequency bands θ₁(x) and θ₂(x) to the control-signal generator 163.

In operation S405, the control-signal generator 163 determines the number “cnt1” of frequency bands θ₁(x) included in the predetermined frequency range. The control-signal generator 163 also determines the number “cnt2” of frequency bands θ₂(x) included in the predetermined frequency range. It is preferable that the predetermined range be set so as to include only a frequency band (e.g., 0 to 9000 Hz or 20 to 9000 Hz) in which deterioration of the audio quality is easily perceivable by the listener. The predetermined frequency range, however, may also be set so as to include all frequency bands in which frequency signals of the respective channels are generated.

In operation S406, the control-signal generator 163 determines whether or not the number “cnt1” of, in the predetermined frequency range, frequency bands in which the signals are likely to be attenuated is larger than or equal to a predetermined number Thn (which is at least 1 or larger) and the similarity α₁ between the left-channel time signal and the center-channel time signal is larger than the similarity threshold Tha.

When cnt1 is larger than or equal to the predetermined number Thn and the similarity α₁ is larger than the similarity threshold Tha (Yes in operation S406), the control-signal generator 163 selects the prediction mode. Accordingly, in operation S408, the control-signal generator 163 generates a control signal for the selectors 14 and 15 so as to cause the second downmixer 13 to use the prediction mode.

On the other hand, when cnt1 is smaller than the predetermined number Thn or the similarity α₁ is smaller than the similarity threshold Tha (No in operation S406), the possibility that the left-channel time signal and the center-channel time signal cancel each other out is low. Thus, in operation S407, the control-signal generator 163 determines whether or not the number “cnt2” of, in the predetermined frequency range, frequency bands in which the signals are likely to be attenuated is larger than or equal to the predetermined number Thn and the similarity α₂ between the right-channel time signal and the center-channel time signal is larger than the similarity threshold Tha. When cnt2 is larger than or equal to the predetermined number Thn and the similarity α₂ is larger than the similarity threshold Tha (Yes in operation S407), the control-signal generator 163 selects the prediction mode. Accordingly, in operation S408, the control-signal generator 163 generates a control signal for the selectors 14 and 15 so as to cause the second downmixer 13 to use the prediction mode.

On the other hand, when cnt2 is smaller than the predetermined number Thn or the similarity α₂ is smaller than the similarity threshold Tha (No in operation S407), the possibility that the right-channel time signal and the center-channel time signal cancel each other out is low.

Accordingly, in operation S409, the control-signal generator 163 generates a control signal for the selectors 14 and 15 so as to cause the second downmixer 13 to use the energy-based mode.

Subsequent to operation S408 or S409, the control-signal generator 163 outputs the control signal to the selectors 14 and 15. Thereafter, the determiner 16 ends the spatial-information generation-mode selection processing.

The determiner 16 may also interchange the order of the processing in operation S406 and the processing in operation S407.

The predetermined number Thn may be set to a value of 2 or greater so that the prediction mode is selected only when cnt1 or cnt2 is 2 or greater. The similarity threshold Tha is set to, for example, 0.7, similarity to the similarity threshold in the above-described embodiment.

According to an embodiment, frequency bands in which the signals of two channels can cancel each other out and are likely to be attenuated by downmixing thereof are estimated. Accordingly, the audio encoding device 2 can check whether or not such frequency bands are included in a frequency range in which deterioration of the sound quality is easily perceivable by the listener. Thus, the audio encoding device 2 can generate spatial information in the prediction mode, only when frequency bands in which the signals are likely to be attenuated are included in a predetermined frequency range in which deterioration of the sound quality is easily perceivable by the listener. It is, therefore, possible to more appropriately select the spatial-information generation mode.

In the above-described embodiments, the similarity calculator 161 and the phase-difference calculator 162 may directly calculate the similarity and the phase difference from the multi-channel signals of the original multi-channel audio signals. For example, when the similarity and the phase difference between the signal of the left channel or right channel and the signal of the center channel are calculated as the similarity and the phase difference between the frequency signal of the left channel or right channel and the frequency signal of the center channel, the similarities α₁ and α₂ and the phase difference θ₁ and θ₂ are determined according to:

$${α}_{1} = \frac{\vert {e}_{LC} \vert}{\sqrt{{e}_{L} {e}_{C}}} , \\ {α}_{2} = \frac{\vert {e}_{RC} \vert}{\sqrt{{e}_{R} {e}_{C}}} \\ {θ}_{1} = ∠ {e}_{LC} = arctan ( \frac{Im ( {e}_{LC} )}{Re ( {e}_{LC} )} ) , \\ {θ}_{2} = ∠ {e}_{RC} = arctan ( \frac{Im ( {e}_{RC} )}{Re ( {e}_{RC} )} ) \\ \begin{matrix}{e}_{L} = {\sum }_{k = 0}^{K - 1} {\sum }_{n = 0}^{N - 1} {\vert {L}_{in} ( k , n ) \vert}^{2} \\ = {\sum }_{k = 0}^{K - 1} {\sum }_{n = 0}^{N - 1} {\vert L ( k , n ) + SL ( k , n ) \vert}^{2}\end{matrix} \\ \begin{matrix}{e}_{R} = {\sum }_{k = 0}^{K - 1} {\sum }_{n = 0}^{N - 1} {\vert {R}_{in} ( k , n ) \vert}^{2} \\ = {\sum }_{k = 0}^{K - 1} {\sum }_{n = 0}^{N - 1} {\vert R ( k , n ) + SR ( k , n ) \vert}^{2}\end{matrix} \\ \begin{matrix}{e}_{C} = {\sum }_{k = 0}^{K - 1} {\sum }_{n = 0}^{N - 1} {\vert {C}_{in} ( k , n ) \vert}^{2} \\ = {\sum }_{k = 0}^{K - 1} {\sum }_{n = 0}^{N - 1} {\vert C ( k , n ) + LFE ( k , n ) \vert}^{2}\end{matrix} \\ \begin{matrix}{e}_{LC} = {\sum }_{k = 0}^{K - 1} {\sum }_{n = 0}^{N - 1} {L}_{in} ( k , n ) \cdot {C}_{in} ( k , n ) \\ = {\sum }_{k = 0}^{K - 1} {\sum }_{n = 0}^{N - 1} \{ L ( k , n ) + SL ( k , n ) \} \cdot \{ C ( k , n ) + LFE ( k , n ) \}\end{matrix} \\ \begin{matrix}{e}_{RC} = {\sum }_{k = 0}^{K - 1} {\sum }_{n = 0}^{N - 1} {R}_{in} ( k , n ) \cdot {C}_{in} ( k , n ) \\ = {\sum }_{k = 0}^{K - 1} {\sum }_{n = 0}^{N - 1} \{ R ( k , n ) + SR ( k , n ) \} \cdot \{ C ( k , n ) + LFE ( k , n ) \}\end{matrix} \qquad ( 21 )$$

According to still another embodiment, the channel-signal encoder in the audio encoding device may encode stereo frequency signals in accordance with other coding. For example, the channel-signal encoder 17 may encode all frequency signals in accordance with the AAC coding. In such a case, in the audio encoding device 1 illustrated in FIG. 1, the SBR encoder 171 may be eliminated.

The multi-channel audio signals to be encoded are not limited to 5.1-channel audio signals. For example, the audio signals to be encoded may be audio signals carrying multiple channels, such as 3 channels, 3.1 channels, or 7.1 channels. In such a case, the audio encoding device determines frequency signals of the respective channels by performing time-frequency transform on the audio signals of the channels. The audio encoding device then downmixes the frequency signals of the channels to generate frequency signals carrying a smaller number of channels than the original audio signals. In this case, with respect to any of the channels, the audio encoding device generates one frequency signal by downmixing the frequency signals of two channels and also generates, in the energy-based mode or the prediction mode, spatial information for the two frequency signals downmixed. The audio encoding device then determines the similarity and the phase difference between the two frequency signals. The audio encoding device may select the prediction mode, when the similarity is large and the phase difference is large, and may select, otherwise, the energy-based mode. In particular, when audio signals to be encoded are 3-channel audio signals, stereo frequency signals can be directly generated by the second downmixer 13 and thus the first downmixer 12 in the above-described embodiments can be eliminated.

A computer program for causing a computer to realize the functions of the units included in the audio encoding device in each of the above-described embodiments may also be stored in/on a recording medium, such as a semiconductor memory, magnetic recording medium, or optical recording medium, for distribution.

The audio encoding device in each embodiment described above may be incorporated into various types of equipment used for transmitting or recording audio signals. Examples of the equipment include a computer, a video-signal recorder, and a video transmitting apparatus.

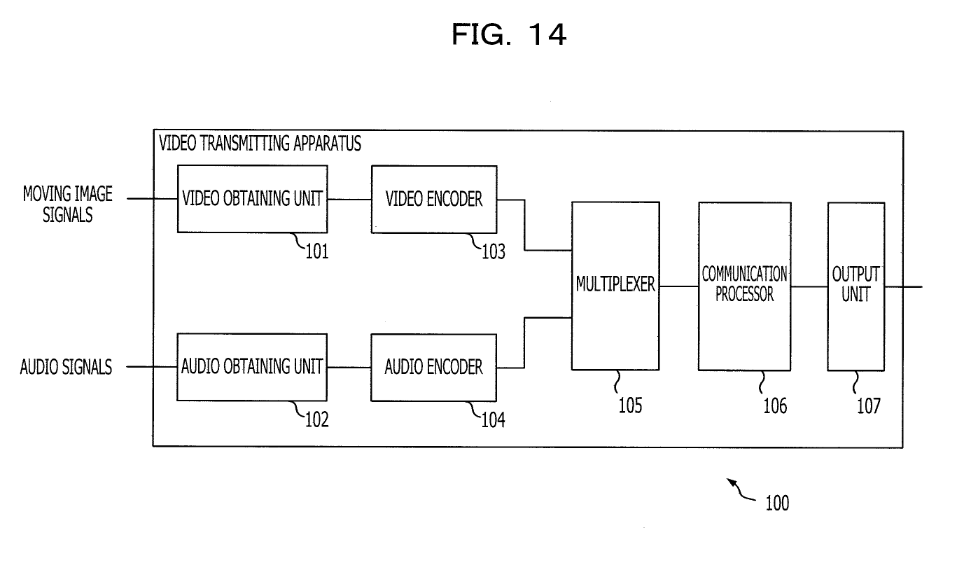

FIG. 14 is a schematic block diagram of a video transmitting apparatus incorporating the audio encoding device according one of the above-described embodiments. A video transmitting apparatus 100 includes a video obtaining unit 101, an audio obtaining unit 102, a video encoder 103, an audio encoder 104, a multiplexer 105, a communication processor 106, and an output unit 107.

The video obtaining unit 101 has an interface circuit for obtaining moving-image signals from another apparatus, such as a video camera. The video obtaining unit 101 passes the moving-image signals, input to the video transmitting apparatus 100, to the video encoder 103.

The audio obtaining unit 102 has an interface circuit for obtaining multi-channel audio signals from another device, such as a microphone. The audio obtaining unit 102 passes the multi-channel audio signals, input to the video transmitting apparatus 100, to the audio encoder 104.

The video encoder 103 encodes the video-image signals in order to compress the amount of data of the moving image signals. To this end, the video encoder 103 encodes the moving-image signals in accordance with a moving-image coding standard, such as MPEG-2, MPEG-4, or H.264 MPEG-4 Advanced Video Coding (AVC). The video encoder 103 outputs encoded moving-image data to the multiplexer 105.

The audio encoder 104 has the audio encoding device according to one of the above-described embodiments. The audio encoder 104 generates stereo-frequency signals and spatial information on the basis of the multi-channel audio signals. The audio encoder 104 encodes the stereo frequency signals by performing AAC encoding processing and SBR encoding processing. The audio encoder 104 encodes the spatial information by performing spatial-information encoding processing. The audio encoder 104 generates encoded audio data by multiplexing generated AAC code, SBR code, and MPS code. The audio encoder 104 then outputs the encoded audio data to the multiplexer 105.

The multiplexer 105 multiplexes the encoded moving-image data and the encoded audio data. The multiplexer 105 then creates a stream according to a predetermined format for transmitting video data. One example of the stream is an MPEG-2 transport stream.

The multiplexer 105 outputs the stream, obtained by multiplexing the encoded moving-image data and the encoded audio data, to the communication processor 106.

The communication processor 106 divides the stream, obtained by multiplexing the encoded moving-image data and the encoded audio data, into packets according to a predetermined communication standard, such as TCP/IP. The communication processor 106 adds a predetermined head, which contains destination information and so on, to each packet. The communication processor 106 then passes the packets to the output unit 107.

The output unit 107 has an interface circuit for connecting the video transmitting apparatus 100 to a communications network. The output unit 107 outputs the packets, received from the communication processor 106, to the communications network.

As mentioned above, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described above in detail, it should be understood that various changes, substitutions, and alterations could be made hereto without departing from the spirit and scope of the present invention, the scope of which is defined in the claims and their equivalents.

What is claimed is:

1. An audio encoding device comprising:
a time-frequency transformer that transforms signals of channels included in audio signals into frequency signals of respective channels by performing a time-frequency transform for each frame having a predetermined time length;
a first spatial-information determiner that generates a frequency signal of a third channel by downmixing the frequency signal of at least one first channel of the channels and the frequency signal of at least one second channel of the channels and that determines first spatial information with respect to the frequency signal of the at least one first channel and the frequency signal of the at least one second channel;
a second spatial-information determiner that generates a frequency signal of the third channel by downmixing the frequency signal of the at least one first channel and the frequency signal of the at least one second channel and that determines second spatial information with respect to the frequency signal of the at least one first channel and the frequency signal of the at least one second channel; the second spatial information having a smaller amount of information than the first spatial information;
a similarity calculator that calculates a similarity between the frequency signal of the at least one first channel and the frequency signal of the at least one second channel;
a phase-difference calculator that calculates a phase difference between the frequency signal of the at least one first channel and the frequency signal of the at least one second channel;
a controller that controls determination of the first spatial information when a similarity and the phase difference satisfy a predetermined determination condition and determination of the second spatial information when the similarity and the phase difference do not satisfy the predetermined determination condition;
a channel-signal encoder that encodes the frequency signal of the third channel; and
a spatial-information encoder that encodes the first spatial information or the second spatial information.

2. The device according to claim 1, wherein the predetermined determination condition is that the similarity is high and the phase difference is large to such a degree that the frequency signal of the third change is attenuated by downmixing the frequency signal of the at least one first channel and the frequency signal of the at least one second channel.

3. The device according to claim 1, wherein the similarity calculator corrects the frequency signal of the at least one first channel so as to cancel the phase difference calculated by the phase-difference calculator and calculates the similarity between the signal of the corrected frequency signal of the at least one first channel and the frequency signal of the at least one second channel.

4. The device according to claim 1, wherein the similarity calculator calculates the similarity for each frequency band;
wherein the phase-difference calculator calculates the phase difference for each frequency band; and
wherein, when a number of, in a predetermined frequency range, frequency bands in which the similarity and the phase difference satisfy the predetermined determination condition is larger than or equal to a predetermined number that is 1 or greater, the controller causes the first spatial-information determiner to determine the first spatial information, and when the number of frequency bands in which the similarity and the phase difference satisfy the predetermined determination condition is smaller than the predetermined number, the controller causes the second spatial-information determiner to determine the second spatial information.

5. The device according to claim 4, wherein a predetermined frequency range is a frequency range in which deterioration of a quality of the audio signals is perceivable by a listener.

6. The device according to claim 1, wherein the frequency signal of the at least one first channel and the frequency signal of the at least one second channel are a frequency signal of the at least one first channel and a frequency signal of the at least one second channel, respectively.

7. The device according to claim 1, wherein the frequency signal of the at least one first channel and the frequency signal of the at least one second channel are a time-domain signal of the at least one first channel and a time-domain signal of the at least one second channel, respectively;
wherein the phase-difference calculator uses, as the phase difference, an amount of shift in time when the frequency signal of the at least one first channel and the frequency signal of the at least one second channel are most similar to each other and estimates, in accordance with the phase difference, an attenuation frequency band in which the third frequency signal obtained by downmixing the frequency signal of the at least one first channel and the frequency signal of the at least one second channel are likely to be attenuated; and
wherein the predetermined determination condition is that the similarity is larger than a predetermined similarity threshold and the number of attenuation frequency bands is larger than or equal to at least one predetermined number.

8. An audio encoding method, comprising:
transforming signals of channels included in audio signals into frequency signals of respective channels by performing time-frequency transform for each frame having a predetermined time length;
calculating a similarity between a frequency signal of at least one first channel of the channels and a frequency signal of at least one second channel of the channels;
calculating a phase difference between the frequency signal of the at least one first channel and the frequency signal of the at least one second channel;
generating a frequency signal of a third channel by downmixing the frequency signal of the at least one first channel and the frequency signal of the at least one second channel;
determining first spatial information with respect to the frequency signal of the at least one first channel and the frequency signal of the at least one second channel when a similarity and the phase difference satisfy a predetermined determination condition;
determining second spatial information with respect to the frequency signal of the at least one first channel and the frequency signal of the at least one second channel when the similarity and the phase difference do not satisfy the predetermined determination condition, the second spatial information having a smaller amount of information than the first spatial information;
encoding the frequency signal of the third channel; and
encoding the first spatial information or the second spatial information.

9. The method according to claim 8, wherein the predetermined determination condition is that the similarity is high and the phase difference is large to such a degree that the frequency signal of the third change is attenuated by downmixing the frequency signal of the at least one first channel and the frequency signal of the at least one second channel.

10. The method according to claim 8, wherein, in the similarity calculating, the frequency signal of the at least one first channel is corrected so as to cancel the phase difference calculated in the phase-difference calculating and the similarity between the signal of the corrected frequency signal of the at least one first channel and the frequency signal of the at least one second channel is calculated.

11. The method according to claim 8, wherein, in the similarity calculating, the similarity is calculated for each frequency band;
wherein, in the phase-difference calculating, the phase difference is calculated for each frequency band; and
wherein, in the first-spatial-information determining, the first spatial information is determined when the number of, in a predetermined frequency range, frequency bands in which the similarity and the phase difference satisfy the predetermined determination condition is larger than or equal to a predetermined number that is 1 or greater, and in the second-spatial-information determining, the second spatial information is determined when the number of frequency bands in which the similarity and the phase difference satisfy the predetermined determination condition is smaller than the predetermined number.

12. The method according to claim 11, wherein a predetermined frequency range is a frequency range in which deterioration of a quality of the audio signals is perceivable by a listener.

13. The method according to claim 8, wherein the frequency signal of the at least one first channel and the frequency signal of the at least one second channel are a frequency signal of the at least one first channel and a frequency signal of the at least one second channel, respectively.

14. A computer-readable non transitory storage medium storing an audio-encoding program that causes a computer to execute a process comprising:
transforming signals of channels included in audio signals into frequency signals of the respective channels by performing time-frequency transform for each frame having a predetermined time length;
calculating a similarity between the frequency signal of at least one first channel of the channels and the frequency signal of at least one second channel of the channels;
calculating a phase difference between the frequency signal of the at least one first channel and the frequency signal of the at least one second channel;
generating a frequency signal of a third channel by downmixing the frequency signal of the at least one first channel and the frequency signal of the at least one second channel;
determining first spatial information with respect to the frequency signal of the at least one first channel and the frequency signal of the at least one second channel when the similarity and the phase difference satisfy a predetermined determination condition;
determining second spatial information with respect to the frequency signal of the at least one first channel and the frequency signal of the at least one second channel when the similarity and the phase difference do not satisfy the predetermined determination condition, the second spatial information having a smaller amount of information than the first spatial information;
encoding the frequency signal of the third channel; and
encoding the first spatial information or the second spatial information.

15. The computer-readable non transitory storage medium according to claim 14, wherein the predetermined determination condition is that the similarity is high and the phase difference is large to such a degree that the frequency signal of the third change is attenuated by downmixing the frequency signal of the at least one first channel and the frequency signal of the at least one second channel.

16. The computer-readable non transitory storage medium according to claim 14, wherein, in the similarity calculating, the frequency signal of the at least one first channel is corrected so as to cancel the phase difference calculated in the phase-difference calculating and the similarity between the signal of the corrected frequency signal of the at least one first channel and the frequency signal of the at least one second channel is calculated.

17. The computer-readable non transitory storage medium according to claim 14, wherein, in the similarity calculating, the similarity is calculated for each frequency band;
wherein, in the phase-difference calculating, the phase difference is calculated for each frequency band; and
wherein, in the first-spatial-information determining, the first spatial information is determined when the number of, in a predetermined frequency range, frequency bands in which the similarity and the phase difference satisfy the predetermined determination condition is larger than or equal to a predetermined number that is 1 or greater, and in the second-spatial-information determining, the second spatial information is determined when the number of frequency bands in which the similarity and the phase difference satisfy the predetermined determination condition is smaller than the predetermined number.

18. The computer-readable non transitory storage medium according to claim 17, wherein a predetermined frequency range is a frequency range in which deterioration of a quality of the audio signals is perceivable by a listener.

19. The computer-readable non transitory storage medium according to claim 14, wherein the frequency signal of the at least one first channel and the frequency signal of the at least one second channel are a frequency signal of the at least one first channel and a frequency signal of the at least one second channel, respectively.
